(19) United States
(12) Patent Application Publication
(10) Pub. No.: US 2021/0149693 A1
(43) Pub. Date: May 20, 2021

(54) INTERFACE DISPLAY METHOD AND APPARATUS, TERMINAL, AND STORAGE MEDIUM

(71) Applicant: Huawei Technologies Co., Ltd., Shenzhen (CN)

(72) Inventors: Dongqi YANG, Shenzhen (CN); Xueyan HUANG, Shenzhen (CN); Zhongli DONG, Shenzhen (CN); Li HUA, Shenzhen (CN); Peng GE, Shenzhen (CN)

(21) Appl. No.: 17/127,379

(22) Filed: Dec. 18, 2020

Related U.S. Application Data
(63) Continuation of application No. PCT/CN2020/080384, filed on Mar. 20, 2020.

(30) Foreign Application Priority Data
May 24, 2019 (CN) 201910441862.0

(51) Int. Cl. G06F 9/451; G06F 9/48

(52) U.S. Cl. CPC G06F 9/451; G06F 2209/482; G06F 9/4843

(57) ABSTRACT

This application provides an interface display method and apparatus, a terminal, and a storage medium, and belongs to terminal technologies field. The method includes: an object-of-attention of the user is obtained from an interface of a first application based on an operation behavior of a user on the interface of the first application, key information is extracted from the object-of-attention, and responsive to receiving an application switching instruction, a target function of a second application is triggered on an interface of the second application based on the key information. In this way, key information on an interface of an application may be automatically mined, and reused on an interface of a next application, thereby avoiding a complex operation of manually entering the key information on the interface of the next application by the user. This can improve efficiency for displaying the interface of the next application, thereby improving user experience.

### CROSS-REFERENCE TO RELATED APPLICATIONS

This application is a continuation of International Patent Application No. PCT/CN2020/080384, filed on Mar. 20, 2020, which claims priority to Chinese Patent Application No. 201910441862.0, filed on May 24, 2019. The disclosures of the aforementioned applications are hereby incorporated by reference in their entireties.

### TECHNICAL FIELD

This application relates to the field of terminal technologies, and in particular, to an interface display method and apparatus, a terminal, and a storage medium.

### BACKGROUND

With development of terminal technologies, various applications may be installed on a terminal, and the terminal may display an interface of an application in a process of running the application. For example, in a process of running an e-commerce application, the terminal may display a commodity purchase interface; in a process of running a reading application, the terminal may display a book reading interface; and in a process of running a travel application, the terminal may display a travel guide interface.

Using a social forum application and an e-commerce application as an example, an interface display process may include: in a process in which a terminal displays an interface of the social forum application, when a user sees a recommendation article for a commodity on the interface of the social forum application, becomes very interested in the commodity, and wants to search for the commodity in the e-commerce application, the user needs to switch to a home screen of the terminal and click/tap an icon of the e-commerce application on the home screen; the terminal responds to the click/tap operation and displays an interface of the e-commerce application; the user finds a search box on the interface of the e-commerce application and manually enters a commodity name into the search box by performing an input operation; and the e-commerce application obtains, based on the input operation of the user, the commodity name entered by the user, and displays, in the search box, the commodity name entered by the user.

It can be learned from the foregoing example that, in a process in which the terminal switches between different applications, the user needs to perform an input operation on an interface of an application to manually enter information that is on an interface of a previous application, so that the terminal can display, on the interface of the application, the information that is on the interface of the previous application. This manner depends on the manual input operation, resulting in complex steps and comparatively low efficiency in the interface display process.

### SUMMARY

Embodiments of this application provide an interface display method and apparatus, a terminal, and a storage medium, to simplify steps of an interface display process and improve interface display efficiency. The technical solutions are as follows.

According to an aspect, an interface display method is provided, and the method includes:

obtaining an object-of-attention of a user from an interface of a first application based on an operation behavior of the user on the interface of the first application;

extracting key information from the object-of-attention; and

if an application switching instruction is received, triggering, on an interface of a second application, a target function of the second application based on the key information, where the application switching instruction is used to indicate to switch the second application to the foreground for running.

According to the method provided in this embodiment, a function of automatically transferring key information on an interface of an application to an interface of a next application is implemented. The object-of-attention of the user is obtained from the interface of the first application based on the operation behavior of the user on the interface of the first application, the key information is extracted from the object-of-attention, and if the application switching instruction is received, the target function of the second application is triggered on the interface of the second application based on the key information. In this way, key information on an interface of an application may be automatically mined, and the key information on the interface of the application is automatically reused on an interface of a next application, thereby avoiding a complex operation of manually entering the key information on the interface of the next application by the user. This can improve efficiency for displaying the interface of the next application, thereby improving user experience.

Optionally, the obtaining an object-of-attention of a user from an interface of a first application based on an operation behavior of the user on the interface of the first application includes at least one of the following:

identifying an attention degree of at least one piece of content on the interface of the first application based on the operation behavior of the user on the interface of the first application; and selecting, from the at least one piece of content, content whose attention degree meets a preset condition, and using the content as the object-of-attention.

The identifying an attention degree of at least one piece of content on the interface of the first application based on the operation behavior of the user on the interface of the first application includes any one of the following:

identifying a first attention degree of the at least one piece of content based on a selection operation of the user on the interface of the first application, where a first attention degree of each piece of content is used to indicate whether the user triggers a selection operation on the content;

identifying a second attention degree of the at least one piece of content based on a saving operation of the user on the interface of the first application, where a second attention degree of each piece of content is used to indicate whether the user triggers a saving operation on the content;

identifying a third attention degree of the at least one piece of content based on a screenshot operation of the user on the interface of the first application, where a third attention degree of each piece of content is used to indicate whether the content is in a screenshot;

identifying a fourth attention degree of the at least one piece of content based on a publishing operation of the user on the interface of the first application, where a fourth attention degree of each piece of content is used to indicate whether the user publishes the content;

detecting, by using a camera, duration in which sight of the user stays on each piece of content on the interface of the first application, and using the duration as a fifth attention degree of the content;

detecting a sliding speed of the user for each piece of content on the interface of the first application, and using the sliding speed as a sixth attention degree of the content;

obtaining a browsing speed for the at least one piece of content based on a browsing behavior of the user on the interface of the first application, and using the browsing speed as a seventh attention degree of the at least one piece of content; and identifying an eighth attention degree of the at least one piece of content based on an interaction behavior of the user on the interface of the first application, where an eighth attention degree of each piece of content is used to indicate whether the user triggers an interaction behavior on the content.

The foregoing provides a plurality of implementations of obtaining an object-of-attention of a user from an interface, and a manner of obtaining an object-of-attention may be selected according to a requirement, thereby improving flexibility.

Optionally, the triggering, on an interface of a second application, a target function of the second application based on the key information includes:

displaying the key information in an editable area on the interface of the second application.

In this implementation, information on an interface of an application may be automatically displayed in an editable area on an interface of a next application, thereby avoiding a complex operation of manually entering the information in the editable area by a user, and improving information input efficiency.

Optionally, the triggering, on an interface of a second application, a target function of the second application based on the key information includes:

displaying the key information in a form of a pop-up box on the interface of the second application.

In this implementation, information on an interface of an application may be automatically displayed in a form of a pop-up box on an interface of a next application, and the user may view the information about the application in the pop-up box, thereby achieving a prompt function and a good display effect.

Optionally, the triggering, on an interface of a second application, a target function of the second application based on the key information includes any one of the following:

storing the key information by using the second application;

determining, based on the key information, a document corresponding to the key information, and displaying the document;

determining, based on the key information, a resource corresponding to the key information, and downloading the resource;

determining, based on the key information, a resource corresponding to the key information, and adding the resource to favorites;

determining, based on the key information, a resource corresponding to the key information, and purchasing the resource;

determining, based on the key information, an audio corresponding to the key information, and playing the audio;

determining, based on the key information, a video corresponding to the key information, and playing the video;

determining, based on the key information, a site corresponding to the key information, and planning a trip to reach the site;

determining, based on the key information, a resource corresponding to the key information, and displaying details about the resource; and

determining, based on the key information, a resource corresponding to the key information, and displaying comment information about the resource.

In this implementation, by analyzing content on an interface of an application, a terminal may fully use mined key information to directly perform various functions in a next application, for example, searching, storing, reading, downloading, adding to favorites, purchasing, playing, planning a trip, displaying a detail interface, and displaying a comment interface, thereby avoiding a complex operation of manually entering the information in the next application. This can improve speeds of various corresponding functions, for example, a search speed and a storage speed, and can greatly improve user experience.

Optionally, the displaying the key information in an editable area on the interface of the second application includes: displaying the key information in a search box on the interface of the second application.

In this implementation, information on an interface of an application may be automatically displayed in a search box on an interface of a next application, thereby avoiding a complex operation of manually entering the information in the search box by the user. This facilitates a quick search by using the next application and improves search efficiency.

Optionally, the displaying the key information in a form of a pop-up box on the interface of the second application includes any one of the following:

displaying the key information in a form of a pop-up prompt on the interface of the second application; and

displaying the key information in a form of a pop-up window on the interface of the second application.

In this implementation, display manners can be diversified, and flexibility is improved.

Optionally, the displaying the key information in a form of a pop-up box on the interface of the second application includes at least one of the following:

processing the key information based on a preset template to obtain text information, and displaying the text information in a form of a pop-up box, where the text information conforms to the preset template and includes the key information; and

if the key information is a picture, displaying the picture in a form of a pop-up box.

Optionally, the extracting key information from the object-of-attention includes at least one of the following:

if the object-of-attention includes a text, extracting a keyword in the text, and using the keyword as the key information;

if the object-of-attention includes a picture, analyzing the picture to obtain the key information;

if the object-of-attention includes a title, extracting the title from the object-of-attention, and using the title as the key information;

if the object-of-attention includes a target word, extracting the target word from the object-of-attention, and using the target word as the key information, wherein a style of the target word is different from that of another word other than the target word in a body text on the interface of the first application;

if the object-of-attention includes a preset symbol, extracting a word in the preset symbol from the object-of-attention, and using the word as the key information; and

if the object-of-attention includes a preset keyword, extracting a word adjacent to the preset keyword from the object-of-attention, and using the word as the key information.

Optionally, the extracting the target word from the object-of-attention includes at least one of the following:

extracting the target word from the object-of-attention based on a font size of a word in the object-of-attention, where a font size of the target word is greater than that of the another word;

extracting the target word from the object-of-attention based on a color of a word in the object-of-attention, where a color of the target word is a non-black-and-white color, or a color of the target word is different from that of the another word; and extracting a bold word from the object-of-attention, and using the bold word as the target word.

Optionally, the extracting the title from the object-of-attention includes at least one of the following:

obtaining a word at a preset position in the object-of-attention, and using the word as the title;

obtaining a word that is in the object-of-attention and that includes fewer characters than a preset quantity of characters, and using the word as the title; and

obtaining a word before a picture in the object-of-attention, and using the word as the title.

According to an aspect, an interface display method is provided, and the method includes:

obtaining key information from an interface of a first application based on an operation behavior of a user on the interface of the first application;

performing semantic analysis on the key information to obtain a semantic meaning of the key information;

querying a correspondence between a semantic meaning and an application based on the semantic meaning of the key information, to obtain a second application corresponding to the semantic meaning of the key information;

displaying prompt information on the interface of the first application, where the prompt information is used to prompt the user whether to jump to the second application; and

displaying an interface of the second application if a confirmation instruction for the prompt information is received.

According to the method provided in this embodiment, a function of automatically indicating a to-be-switched-to application on an interface of a previous application is implemented. The terminal queries the correspondence between a semantic meaning and an application based on the semantic meaning of the key information, to obtain the second application corresponding to the semantic meaning of the key information; displays the prompt information on the interface of the first application; and displays the interface of the second application if the confirmation instruction for the prompt information is received. In this way, by mining information on an interface of an application, a next application that needs to be used by the user is learned of through intelligent analysis, thereby avoiding a complex operation of manually searching for the next application and starting the next application by the user. This can improve efficiency for displaying the interface of the next application, thereby improving user experience.

Optionally, the obtaining key information from an interface of a first application based on an operation behavior of a user on the interface of the first application includes at least one of the following:

obtaining an object-of-attention of the user from the interface of the first application based on the operation behavior of the user on the interface of the first application, and using the object-of-attention as the key information; and obtaining an object-of-attention of the user from the interface of the first application based on the operation behavior of the user on the interface of the first application, and extracting the key information from the object-of-attention.

Optionally, the displaying an interface of the second application includes:

displaying the key information on the interface of the second application based on a target function of the second application.

Optionally, the displaying the key information on the interface of the second application based on a target function of the second application includes any one of the following:

displaying the key information in an editable area on the interface of the second application; and

displaying the key information in a form of a pop-up box on the interface of the second application.

Optionally, the displaying the key information in an editable area on the interface of the second application includes:

displaying the key information in a search box on the interface of the second application.

Optionally, the displaying the key information in a form of a pop-up box on the interface of the second application includes any one of the following:

displaying the key information in a form of a pop-up prompt on the interface of the second application; and

displaying the key information in a form of a pop-up window on the interface of the second application.

Optionally, the displaying the key information in a form of a pop-up box on the interface of the second application includes at least one of the following:

processing the key information based on a preset template to obtain text information, and displaying the text information in a form of a pop-up box, where the text information conforms to the preset template and includes the key information; and

if the key information is a picture, displaying the picture in a form of a pop-up box.

Optionally, the obtaining an object-of-attention of a user from an interface of a first application based on an operation behavior of the user on the interface of the first application includes at least one of the following:

obtaining, from the interface of the first application based on a selection operation of the user on the interface of the first application, content selected by the user, and using the content as the object-of-attention;

obtaining, from the interface of the first application based on a copying operation of the user on the interface of the first application, content copied by the user, and using the content as the object-of-attention;

obtaining, from the interface of the first application based on a saving operation of the user on the interface of the first application, content saved by the user, and using the content as the object-of-attention;

obtaining a screenshot of the interface of the first application based on a screenshot operation of the user on the interface of the first application, and using the screenshot as the object-of-attention;

obtaining, from the interface of the first application according to a publishing instruction triggered by the user on the interface of the first application, content published by the user, and using the content as the object-of-attention;

detecting, by using a camera, duration in which sight of the user stays on each piece of content on the interface of the first application, obtaining content with longest stay duration from the interface of the first application based on stay duration of each piece of content, and using the content as the object-of-attention;

detecting a sliding speed of the user for each piece of content on the interface of the first application, obtaining content with a lowest sliding speed from the interface of the first application based on a sliding speed of each piece of content, and using the content as the object-of-attention;

detecting a browsing speed of the user, and when the browsing speed is lower than a browsing speed threshold, obtaining all content on the interface of the first application, and using the content as the object-of-attention; and obtaining, from the interface of the first application, content for which an interaction instruction is triggered, and using the content as the object-of-attention.

Optionally, the extracting key information from the object-of-attention includes at least one of the following:

if the object-of-attention includes a text, extracting a keyword in the text, and using the keyword as the key information;

if the object-of-attention includes a picture, analyzing the picture to obtain the key information;

if the object-of-attention includes a title, extracting the title from the object-of-attention, and using the title as the key information;

if the object-of-attention includes a target word, extracting the target word from the object-of-attention, and using the target word as the key information, wherein a style of the target word is different from that of another word other than the target word in a body text on the interface of the first application;

if the object-of-attention includes a preset symbol, extracting a word in the preset symbol from the object-of-attention, and using the word as the key information; and

if the object-of-attention includes a preset keyword, extracting a word adjacent to the preset keyword from the object-of-attention, and using the word as the key information.

Optionally, the extracting the target word from the object-of-attention includes at least one of the following:

extracting the target word from the object-of-attention based on a font size of a word in the object-of-attention, where a font size of the target word is greater than that of the another word;

extracting the target word from the object-of-attention based on a color of a word in the object-of-attention, where a color of the target word is a non-black-and-white color, or a color of the target word is different from that of the another word; and extracting a bold word from the object-of-attention, and using the bold word as the target word.

Optionally, the extracting the title from the object-of-attention includes at least one of the following:

obtaining a word at a preset position in the object-of-attention, and using the word as the title;

obtaining a word that is in the object-of-attention and that includes fewer characters than a preset quantity of characters, and using the word as the title; and

obtaining a word before a picture in the object-of-attention, and using the word as the title.

Optionally, after the displaying the key information on the interface of the second application, the method further includes:

if a confirmation instruction for the key information is received, triggering, based on the key information, at least one of the following functions of the second application: a search function, a storage function, a reading function, a download function, a favorites function, a purchase function, a play function, a function of planning a trip, a function of displaying a detail interface, and a function of displaying a comment interface.

According to another aspect, an interface display apparatus is provided. The apparatus is configured to perform the foregoing interface display method. Specifically, the interface display apparatus includes functional modules configured to perform the foregoing interface display method.

According to another aspect, a terminal is provided. The terminal includes one or more processors and one or more memories. The one or more memories store at least one instruction, and the instruction is loaded and executed by the one or more processors to implement the foregoing interface display method.

According to another aspect, a computer readable medium is provided. The computer readable medium stores at least one instruction, and the instruction is loaded and executed by a processor to implement the foregoing interface display method.

According to another aspect, a computer program product is provided. The computer program product includes computer program code, and when the computer program code is run by a terminal, the terminal is enabled to perform the foregoing interface display method.

According to another aspect, a chip is provided, including a processor. The processor is configured to invoke, from a memory, an instruction stored in the memory and run the instruction, so that a terminal on which the chip is installed performs the foregoing interface display method.

According to another aspect, another chip is provided, including an input interface, an output interface, a processor, and a memory. The input interface, the output interface, the processor, and the memory are connected to each other through an internal connection path. The processor is configured to execute code in the memory, and when the code is executed, the processor is configured to perform the foregoing interface display method.

### BRIEF DESCRIPTION OF DRAWINGS

FIG. 1 is an architectural diagram of an implementation environment of an interface display method according to an embodiment of this application;

FIG. 2A and FIG. 2B are schematic diagrams of an interface according to an embodiment of this application;

FIG. 3A, FIG. 3B, and FIG. 3C are schematic diagrams of an interface according to an embodiment of this application;

FIG. 4A and FIG. 4B are schematic diagrams of an interface according to an embodiment of this application;

FIG. 5A and FIG. 5B are schematic diagrams of an interface according to an embodiment of this application;

FIG. 6A and FIG. 6B are schematic diagrams of an interface according to an embodiment of this application;

FIG. 7A and FIG. 7B are schematic diagrams of an interface according to an embodiment of this application;

FIG. 8A, FIG. 8B and FIG. 8C are schematic diagrams of an interface according to an embodiment of this application;

FIG. 9A, FIG. 9B and FIG. 9C is a schematic diagram of an interface according to an embodiment of this application;

FIG. 10 is a schematic structural diagram of a terminal according to an embodiment of this application;

FIG. 11 is a block diagram of a software structure of a terminal according to an embodiment of this application;

FIG. 12 is a flowchart of an interface display method according to an embodiment of this application;

FIG. 13A, FIG. 13B, and FIG. 13C are schematic diagrams of an interface according to an embodiment of this application;

FIG. 14 is a flowchart of an interface display method according to an embodiment of this application;

FIG. 15 is a diagram of a logical functional architecture of an interface display method according to an embodiment of this application;

FIG. 16 is a schematic structural diagram of an interface display apparatus according to an embodiment of this application; and

FIG. 17 is a schematic structural diagram of another interface display apparatus according to an embodiment of this application.

### DESCRIPTION OF EMBODIMENTS

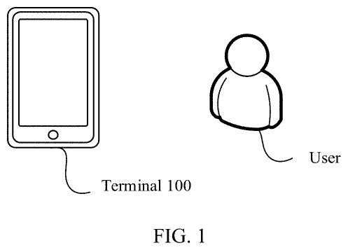

FIG. 1 is a schematic diagram of an implementation environment of an interface display method according to an embodiment of this application. Referring to FIG. 1, the implementation environment includes a terminal 100. The terminal 100 may be any terminal with a display screen. The terminal 100 may be but is not limited to a mobile phone, a tablet computer, a notebook computer, a television, a laptop computer, a desktop computer, a multimedia player, an e-reader, a smart in-vehicle device, a smart home appliance, an artificial intelligence device, a wearable device, an internet of things device, a virtual reality device, an augmented reality device, a mixed reality device, or the like.

A plurality of applications may be installed on the terminal 100, for example, an instant messaging application, an e-commerce application, a game application, a community application, a news application, an audio play application, a live broadcast application, a video play application, a browser application, a travel application, a financial application, a sports application, a photographing application, an image processing application, a reading application, a take-out application, a recipe application, a navigation application, a transportation ticket application, an information recording application, a mailbox application, a medical application, a health application, a blog application, an email application, a picture management application, a video management application, and a file management application. The information recording application may be a memo application, a notepad application, a note application, an office application, or the like. An application installed on the terminal 100 may be an independent application, or may be an embedded application, that is, an applet.

In some possible embodiments, the terminal 100 may display an interface of an application. The interface of the application may include key information, and the key information may be resource-related information. For example, the key information may be an identification of a resource, for example, a name, a model, a keyword, or an identifier (ID) of the resource. For another example, the key information may be alternatively an identification of a category to which a resource belongs. Resources may be objects of users' interest, and the resources include but are not limited to commodities, texts, multimedia files, images, sites, software, and the like. The commodities include but are not limited to food, clothing, footwear, digital products, groceries, home appliances, beauty supplies, wash supplies, accessories, outdoor sports products, articles of daily use, bags and suitcases, home textiles, jewelry, flowers and pets, musical instruments, and the like. The texts include but are not limited to articles, books, movies, news, and the like. The multimedia files include but are not limited to music, movies, TV series, short videos, videos, and the like. The images include but are not limited to pictures and moving pictures. The sites include scenic spots, points of interest (POI), and the like.

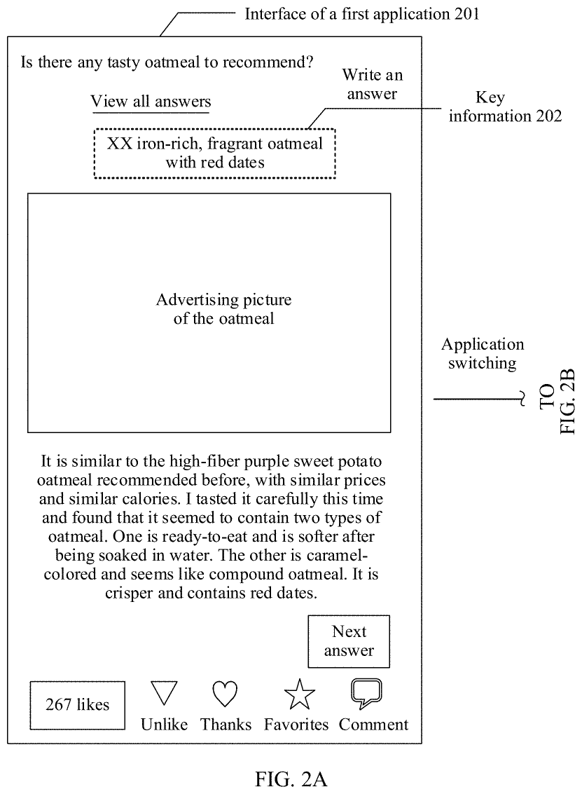

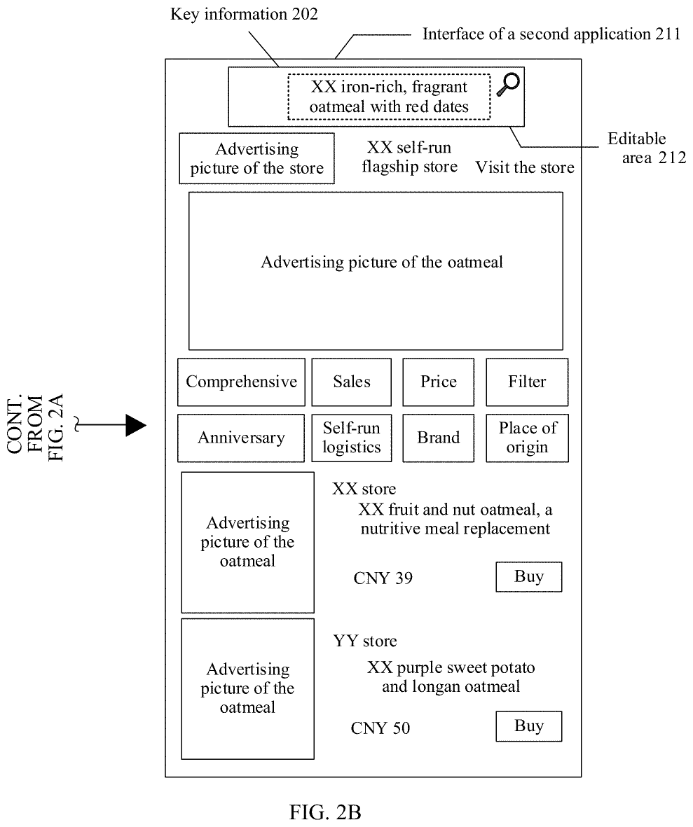

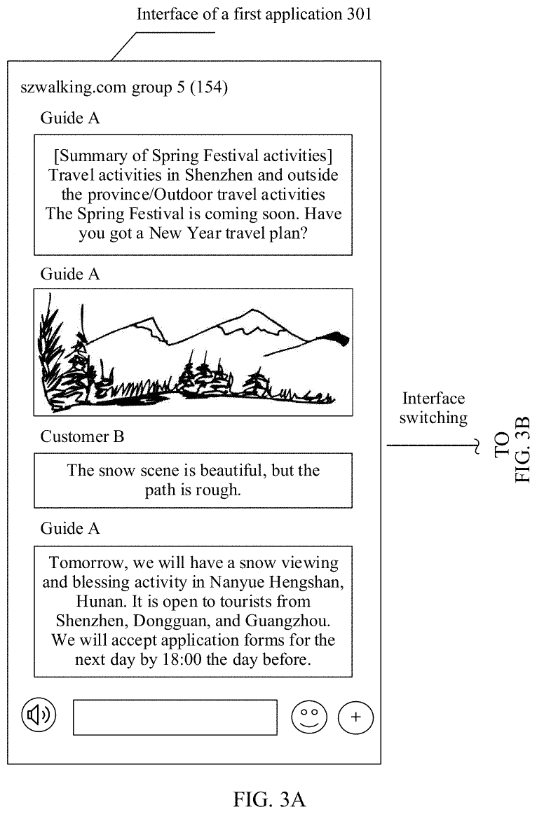

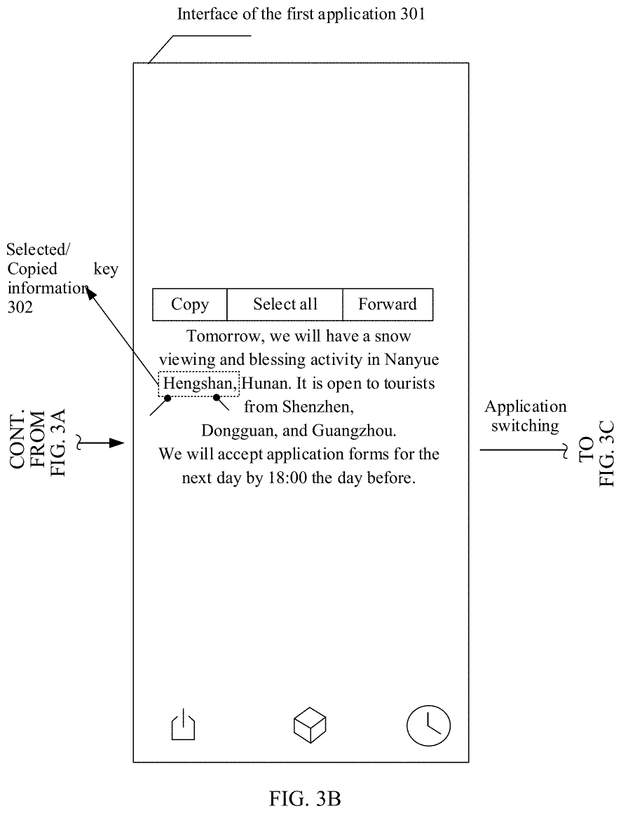

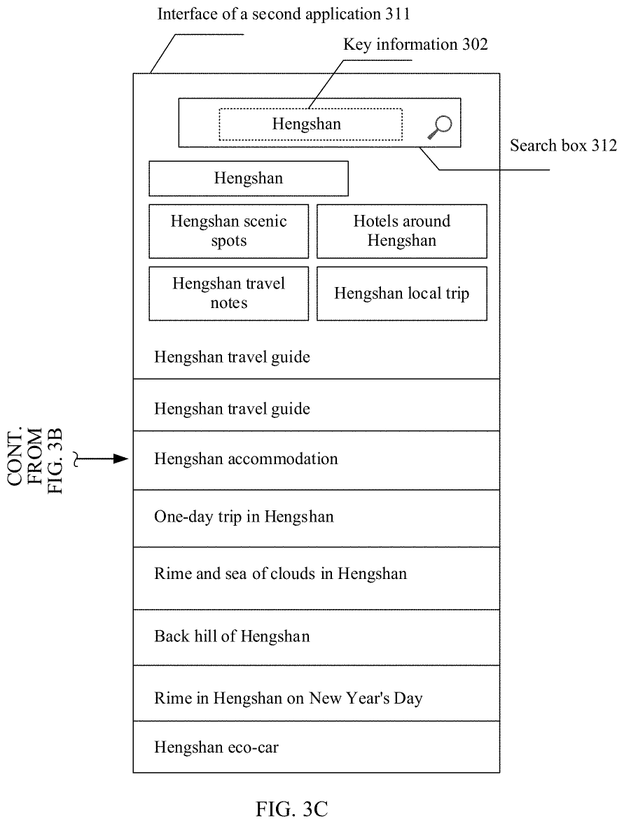

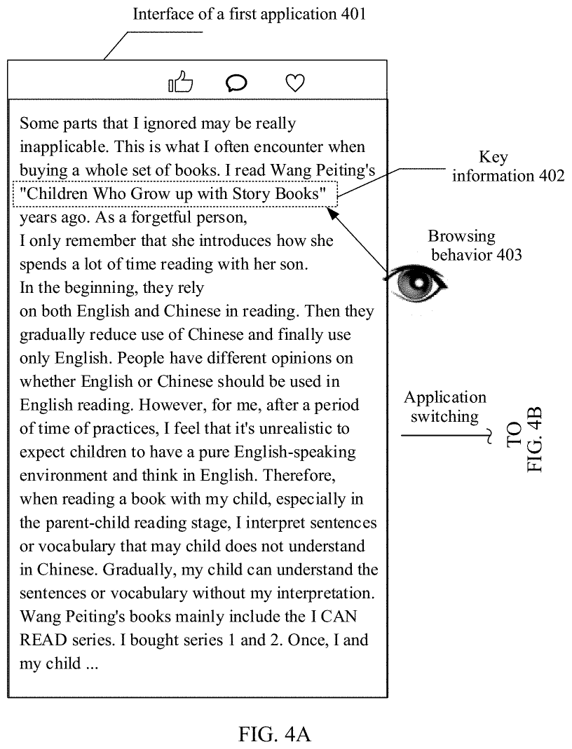

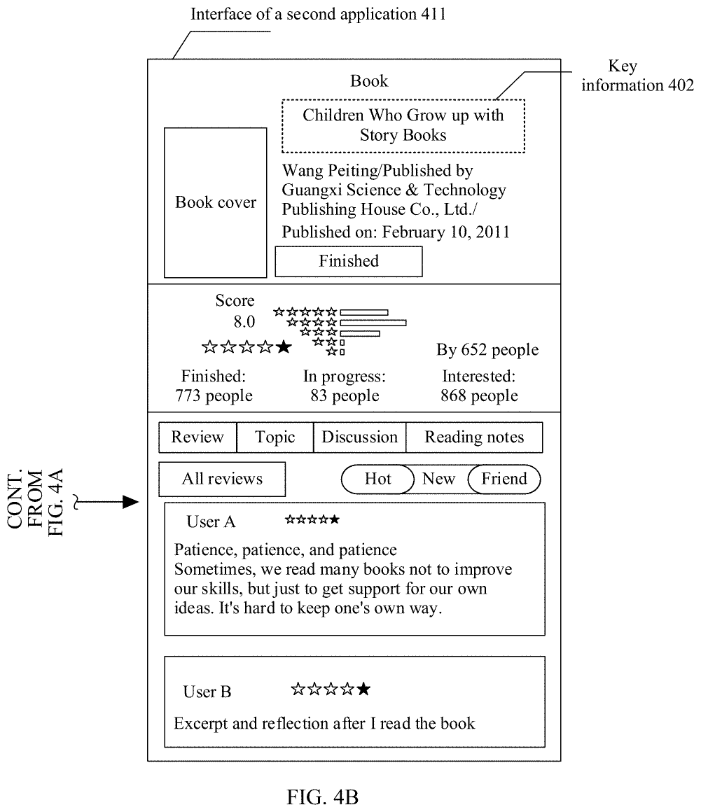

For example, referring to FIG. 2A, the terminal 100 may display an interface 201 of a first application (e.g., a community application). The interface 201 of the community application may be shown in FIG. 2A, namely, a diagram on the left in FIG. 2A. The interface 201 of the community application includes a recommendation article for a commodity. Key information 202 on the interface 201 of the community application may be a name of the commodity or a name of a category to which the commodity belongs. For example, the key information 202 may be “XX iron-rich, fragrant oatmeal with red dates”, oatmeal, or food. For another example, referring to FIG. 3A, the terminal 100 may display an interface 301 of an instant messaging application. The interface 301 of the instant messaging application may be shown in FIG. 3A, namely, a diagram on the left in FIG. 3A. The interface 301 of the instant messaging application includes a recommendation message for a scenic spot. Key information 302 on the interface of the instant messaging application may be a name of the scenic spot, as shown in FIG. 3B. For another example, referring to FIG. 4A, the terminal 100 may display an interface 401 of a browser application. The interface 401 of the browser application may be shown in FIG. 4A, namely, a diagram on the left in FIG. 4A. The interface 401 of the browser application includes a reflection on a book. Key information 402 on the interface 401 of the browser application may be a name of the book or a name of a category to which the book belongs. For example, the key information may be “Children Who Grow up with Story Books” or a parent-child book.

In some possible embodiments, the terminal 100 may provide a resource-related function by using an application based on key information, for example, searching for a resource, reading a resource, storing a resource, downloading a resource, adding a resource to favorites, purchasing a resource, playing a resource, planning a trip to reach resource, displaying a detail interface of resource, or displaying a comment interface of resource.

For example, referring to FIG. 2B, the terminal 100 may display an interface 211 of an e-commerce application. The interface 211 of the e-commerce application may be shown in FIG. 2B. The e-commerce application may search for a commodity based on a name of the commodity. For another example, referring to FIG. 3C, the terminal 100 may display an interface 311 of a travel application. The interface 311 of the travel application may be shown in FIG. 3C. The travel application may plan, based on a name of a scenic spot, a trip to reach the scenic spot. For another example, referring to FIG. 4B, the terminal 100 may display an interface 411 of a reading application. The interface 411 of the reading application may be shown in FIG. 4B. The reading application may display a comment interface of a book based on a name of the book.

This embodiment may be applied to various scenarios of multi-application switching. For example, this embodiment may be applied to a scenario of switching between applications with different functions. For example, this embodiment may be applied to a scenario of switching from any one of an instant messaging application, a community application, and a browser application to any one of an e-commerce application, an information recording application, a reading application, an audio play application, a video play application, a movie ticket booking application, a travel application, and a software download application. For another example, this embodiment may be applied to a scenario of switching between an application and an embedded application in the application. For example, this embodiment may be applied to a scenario of switching from an instant messaging application to an information application or an e-commerce application in the instant messaging application. For another example, this embodiment may be applied to a scenario of switching between different embedded applications in an application. For example, this embodiment may be applied to a scenario of switching between an information application in an instant messaging application and an e-commerce application in the instant messaging application.

In various scenarios of multi-application switching, in a process of displaying an interface of an application, the terminal 100 may mine an object-of-attention of a user from the interface by analyzing the interface of the application, and extract key information from the object-of-attention. When switching to a next application, the terminal 100 automatically displays the key information on an interface of the next application, to achieve an effect of transferring information between different applications, and reuse the key information on the interface of the application. This avoids a complex operation of manually entering the key information on the interface of the next application by the user.

In an example scenario, referring to FIG. 2A, a recommendation article for “XX iron-rich, fragrant oatmeal with red dates” is shown on an interface 201 of a community application. After seeing the recommendation article, a user pays attention to “XX iron-rich, fragrant oatmeal with red dates”, and saves an advertising picture of “XX iron-rich, fragrant oatmeal with red dates” to an album.

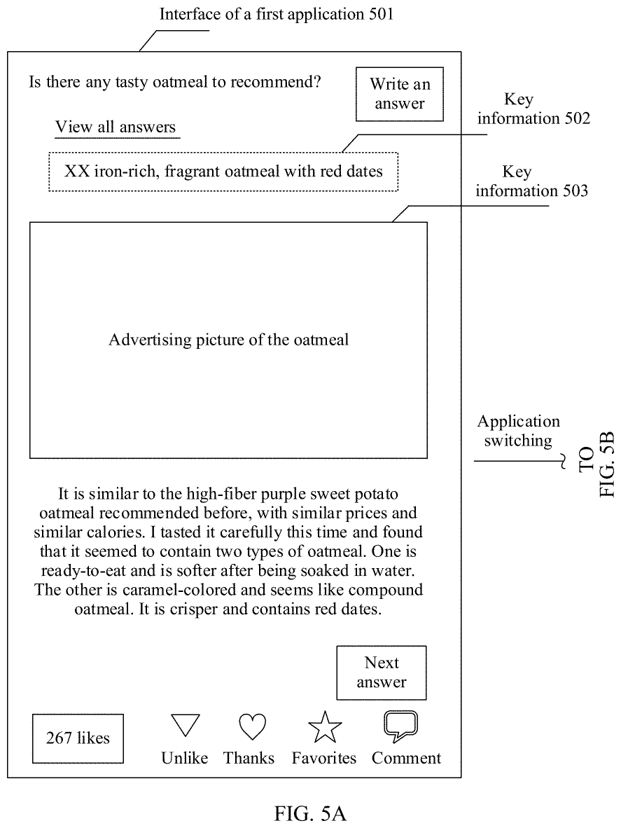

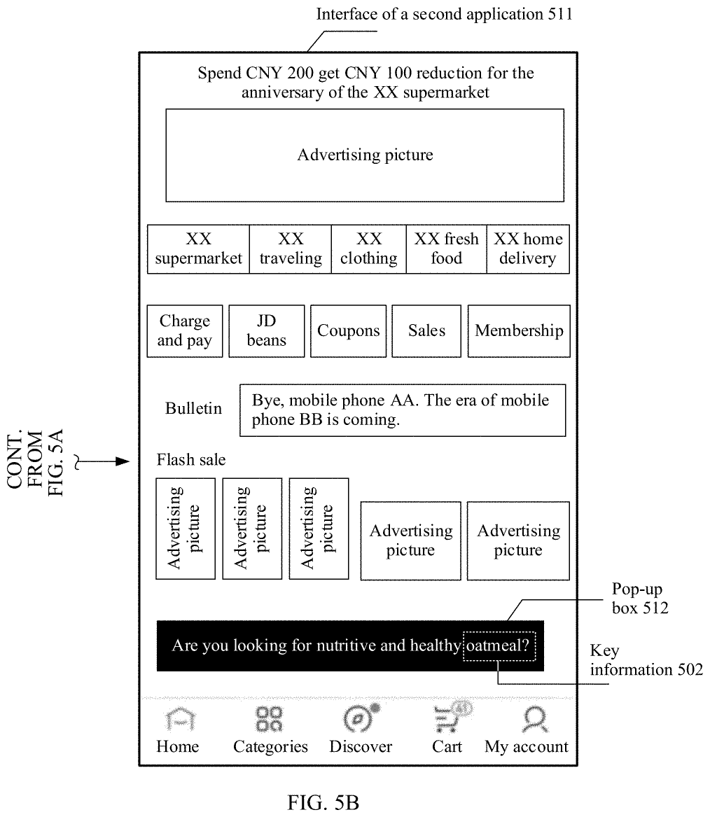

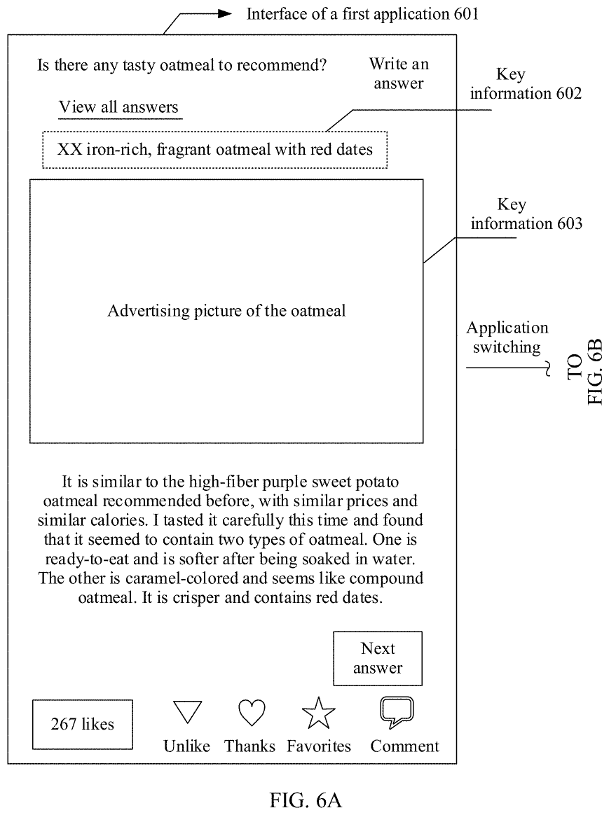

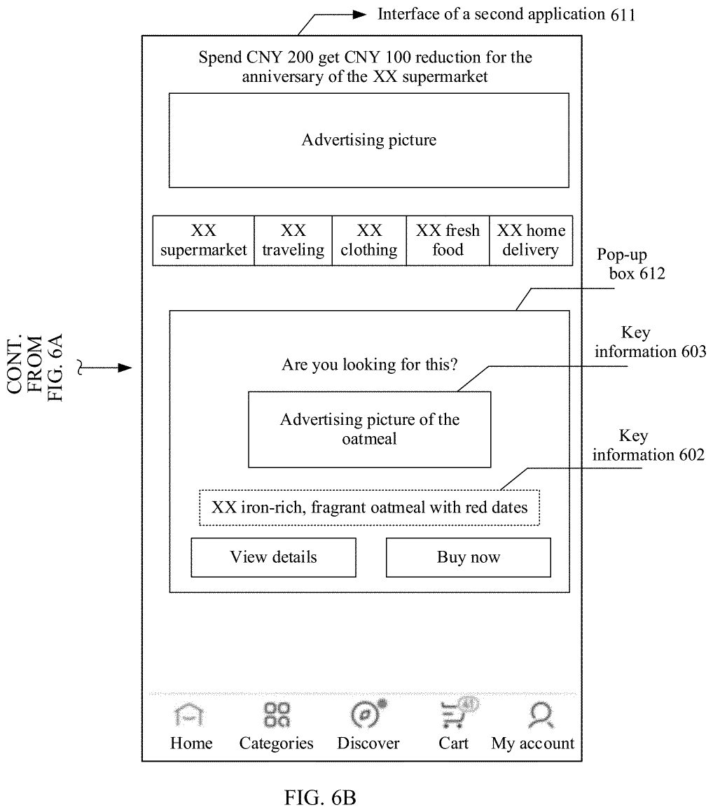

In this scenario, the terminal 100 can learn, through analysis, that “XX iron-rich, fragrant oatmeal with red dates” is key information 202 in FIG. 2A. When switching to an e-commerce application, the terminal 100 may automatically copy and paste “XX iron-rich, fragrant oatmeal with red dates”, and display “XX iron-rich, fragrant oatmeal with red dates” in a search box 212 on an interface 211 of the e-commerce application. In this case, as shown in FIG. 2B, the user can see “XX iron-rich, fragrant oatmeal with red dates” in the search box 212 without manually entering “XX iron-rich, fragrant oatmeal with red dates” in the search box 212. Alternatively, the terminal 100 may automatically display prompt information on the interface 511 of the e-commerce application. In this case, as shown in FIG. 5B, the user may see a prompt 512 on the interface 511 of the e-commerce application: “Are you looking for nutritive and healthy oatmeal?”, to recommend a commodity of the user's interest. Alternatively, the terminal 100 may automatically display a pop-up window 612 on the interface 611 of the e-commerce application. As shown in FIG. 6B, the pop-up window 612 may include graphic 603 and text 602 descriptions of “XX iron-rich, fragrant oatmeal with red dates”, an option for viewing details, and an option for purchasing. In this case, the user can see, in the pop-up window 612 on the interface of the e-commerce application, key information 602/603 about the oatmeal that the user wants to purchase, from the interface 601 of a community application, without manually searching for information about the oatmeal. In addition, the user may further trigger an operation on the option for viewing details to quickly view a detail interface of the oatmeal, and quickly purchase the oatmeal by performing an operation on the option for purchasing.

The terminal 100 may perform multi-application switching in a plurality of switching manners.

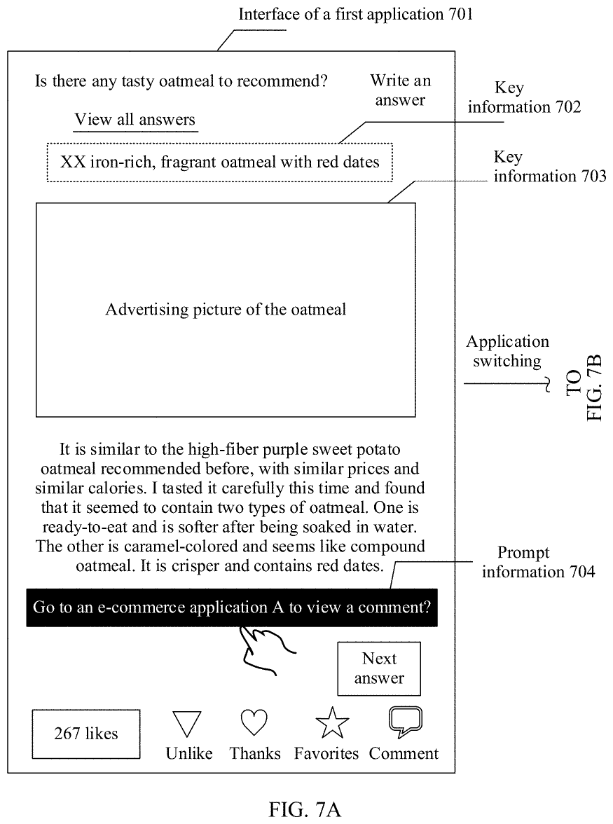

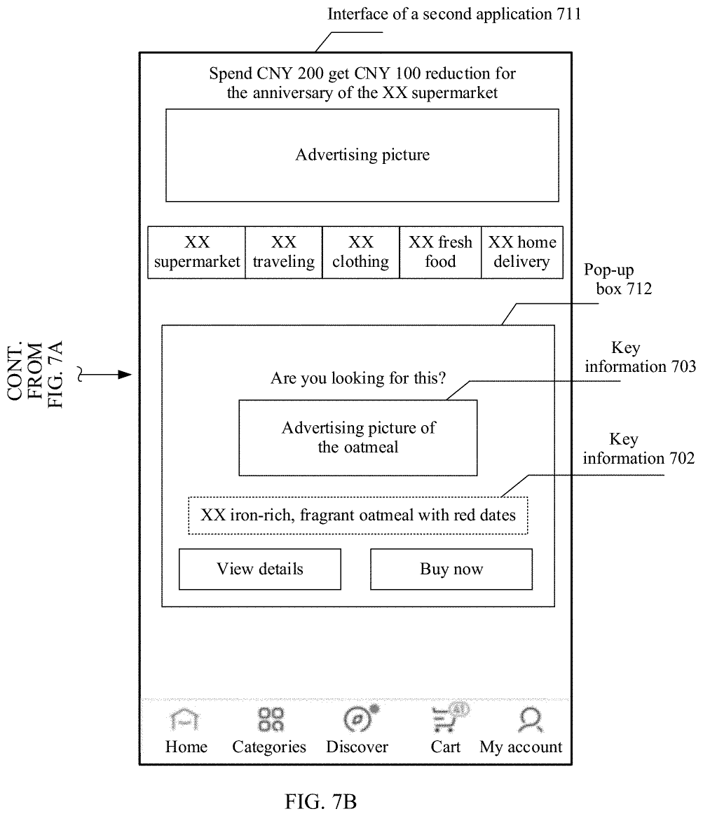

For example, referring to FIG. 7A, the terminal 100 may display prompt information 704 on an interface 701 of a community application: “Go to an e-commerce application A to view a comment?”. The interface 701 also includes key information 702/703. If a user clicks/taps “Go to an e-commerce application A to view a comment?”, the terminal 100 receives a confirmation instruction for the prompt information 704. The terminal 100 responds to the confirmation instruction. As shown in FIG. 7B, the terminal 100 automatically switches to the e-commerce application, and displays an interface 711 of the e-commerce application, which includes the pop-up box 712 displaying key information 702/703. In this process, an operation of manually finding the e-commerce application by the user from all applications installed on the terminal 100 is avoided, and a startup operation of manually triggering the e-commerce application by the user is also avoided, thereby greatly simplifying an application switching process.

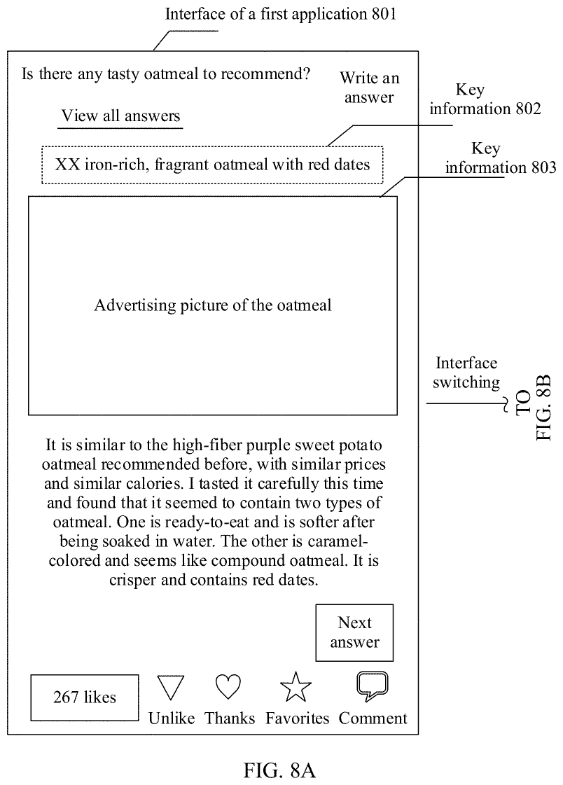

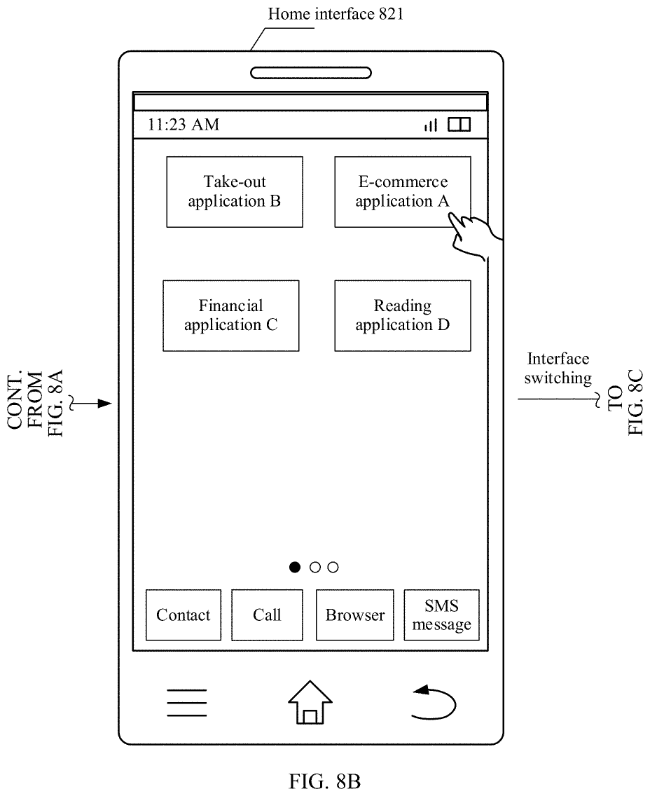

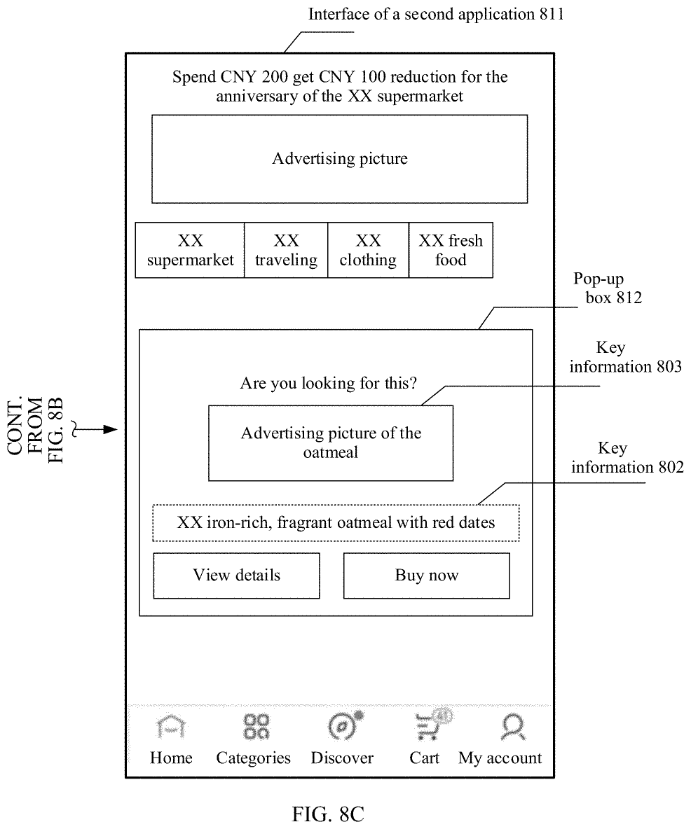

For another example, referring to FIG. 8B, the terminal 100 may display an icon of an e-commerce application on a home screen 821. If a user triggers an operation on the icon of the e-commerce application, the terminal 100 receives an application switching instruction for switching the e-commerce application to the foreground for running. The terminal 100 responds to the application switching instruction. As shown in FIG. 8C, the terminal 100 displays an interface 811 of the e-commerce application, which includes the pop-up box 812 displaying key information 802/803 from an interface 801 of a community application.

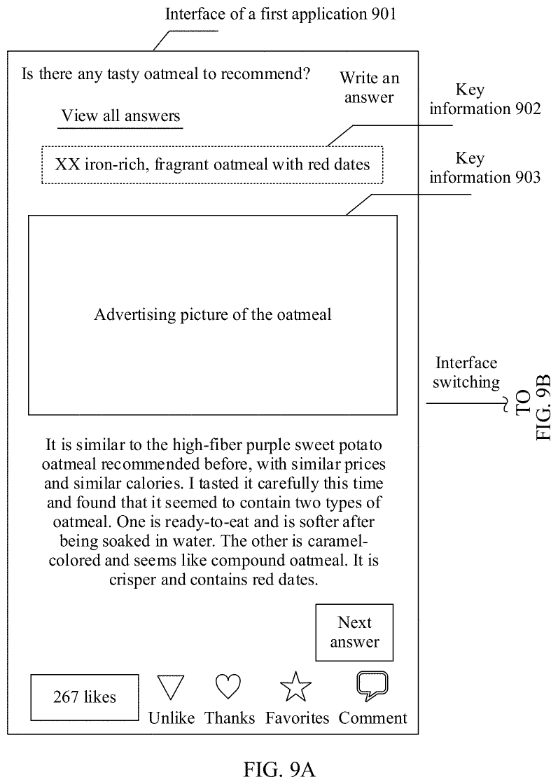

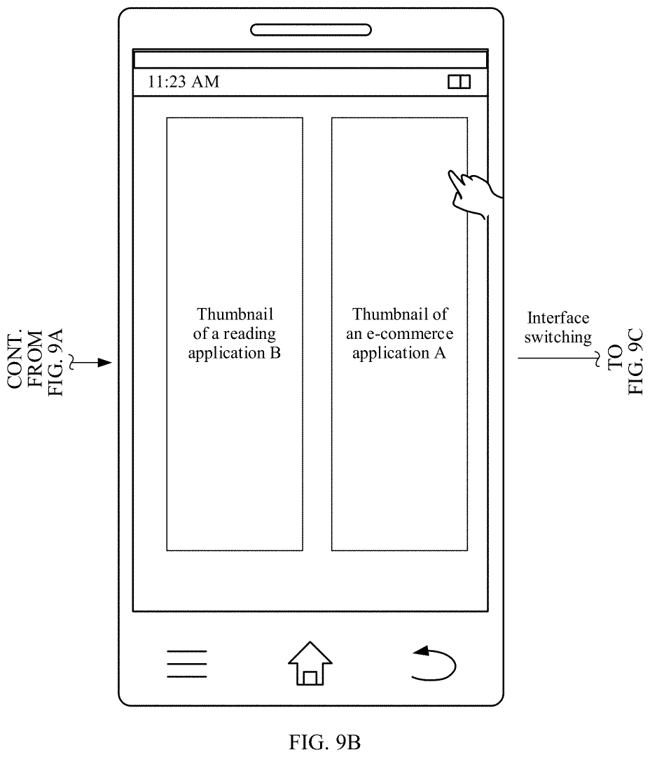

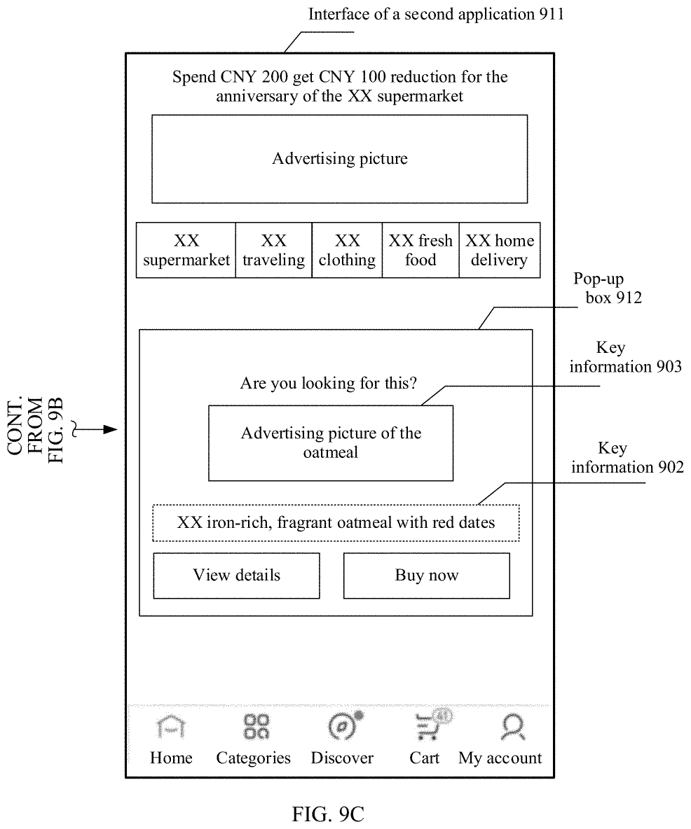

For another example, referring to FIG. 9A, an interface 901 for a community application may be a foreground display application of the terminal 100, and an interface 911 for an e-commerce application may be a background application of the terminal 100. When receiving a background application wakeup instruction, as shown in FIG. 9B, the terminal 100 may display a thumbnail of an e-commerce application on a home screen. If a user triggers an operation on the thumbnail of the e-commerce application, the terminal 100 receives an application switching instruction for switching the interface 911 for the e-commerce application to the foreground for running. The terminal 100 responds to the application switching instruction. As shown in FIG. 9C, the terminal 100 displays an interface 911 of the e-commerce application, which includes pop-up box 912 displaying key information 902/903 from the interface 901 of the community application.

In an example scenario, referring to FIG. 3A, an interface 301 of an instant messaging application is shown, and the interface 301 includes a message that includes “Hengshan” and that is sent by a guide A. After seeing the message, a user triggers a selection operation on the message. As shown in FIG. 3B, the user selects a word “Hengshan” and wants to learn about a trip plan for reaching “Hengshan”. In this case, the terminal 100 can learn, through analysis, that “Hengshan” is key information 302 in FIG. 3A. When switching to a travel application, as shown in FIG. 3C, the terminal 100 automatically pastes “Hengshan” to a search box 312 on an interface 311 of the travel application. In this case, the user can see “Hengshan” in the search box, without manually entering “Hengshan” into the search box.

In an example scenario, referring to FIG. 4A, an interface 401 of a browser application is shown, and the interface 401 includes a recommendation article for “Children Who Grow up with Story Books”. After seeing the recommendation article, a user looks at “Children Who Grow up with Story Books” for a long time (e.g., browsing behavior 403), and wants to read “Children Who Grow up with Story Books”. In this case, the terminal 100 can learn, through analysis, that “Children Who Grow up with Story Books” is key information 402 in FIG. 4A. When switching to a reading application, as shown in FIG. 4B, the terminal 100 automatically displays details about “Children Who Grow up with Story Books” on an interface 411 of the reading application.

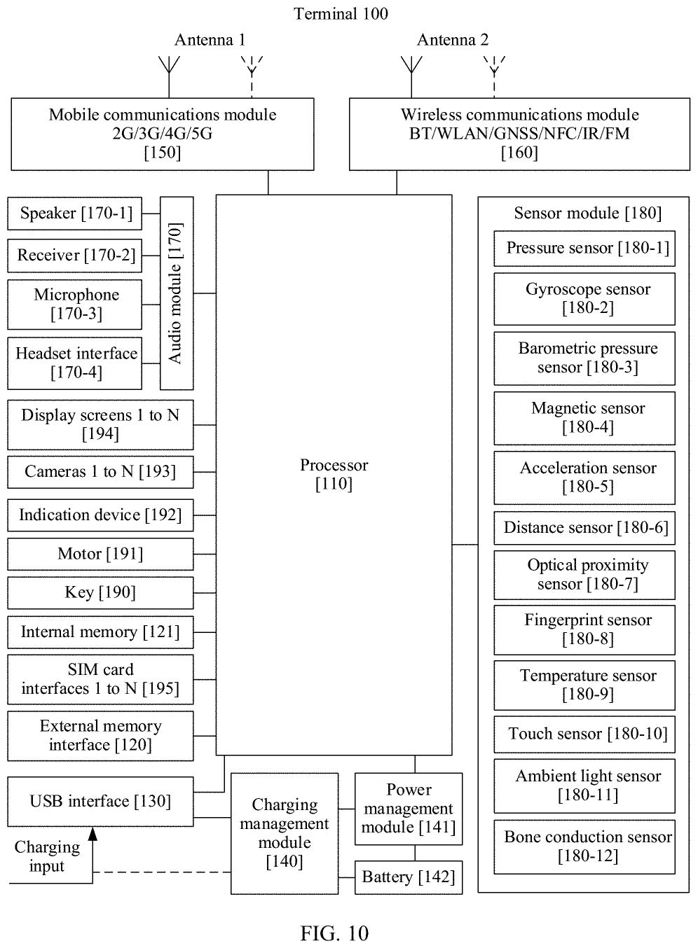

FIG. 10 is a schematic structural diagram of a terminal 100.

The terminal 100 may include a processor 110, an external memory interface 120, an internal memory 121, a universal serial bus (USB) interface 130, a charging management module 140, a power management module 141, a battery 142, an antenna 1, an antenna 2, a mobile communications module 150, a wireless communications module 160, an audio module 170, a speaker 170-1, a receiver 170-2, a microphone 170-3, a headset interface 170-4, a sensor module 180, a key 190, a motor 191, an indication device 192, a camera 193, a display screen 194, a subscriber identification module (SIM) card interface 195, and the like. The sensor module 180 may include a pressure sensor 180-1, a gyroscope sensor 180-2, a barometric pressure sensor 180-3, a magnetic sensor 180-4, an acceleration sensor 180-5, a distance sensor 180-6, an optical proximity sensor 180-7, a fingerprint sensor 180-8, a temperature sensor 180-9, a touch sensor 180-10, an ambient light sensor 180-11, a bone conduction sensor 180-12, and the like.

It can be understood that the structure shown in this embodiment of this application does not constitute a specific limitation on the terminal 100. In some other embodiments of this application, the terminal 100 may include more or fewer components than those shown in the figure, or some components may be combined, or some components may be split, or there may be a different component layout. The components shown in the figure may be implemented by hardware, software, or a combination of software and hardware.

The processor 110 may include one or more processing units. For example, the processor 110 may include an application processor (AP), a modem processor, a graphics processing unit (GPU), an image signal processor (ISP), a controller, a video codec, a digital signal processor (DSP), a baseband processor, and/or a neural-network processing unit (NPU). Different processing units may be separate devices, or may be integrated into one or more processors.

The controller may generate an operation control signal based on an instruction operation code and a time sequence signal, to control obtaining of an instruction and execution of the instruction.

A memory may be further disposed in the processor 110 to store an instruction and data. In some embodiments, the memory in the processor 110 is a cache. The memory may store an instruction or data just used or cyclically used by the processor 110. If the processor 110 needs to use the instruction or the data again, the processor 110 may directly invoke the instruction or the data from the memory. This avoids repeated access and reduces a waiting time of the processor 110, thereby improving system efficiency.

In some embodiments, the processor 110 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) interface, and/or the like.

The I2C interface is a two-way synchronous serial bus, including a serial data line (SDL) and a serial clock line (SCL). In some embodiments, the processor 110 may include a plurality of I2C buses. The processor 110 may be coupled to the touch sensor 180-10, a charger, a flash, the camera 193, and the like separately by using different I2C interfaces. For example, the processor 110 may be coupled to the touch sensor 180-10 by using an I2C interface, so that the processor 110 communicates with the touch sensor 180-10 by using the I2C interface, to implement a touch function of the terminal 100.

The I2S interface may be used for audio communication. In some embodiments, the processor 110 may include a plurality of I2S buses. The processor 110 may be coupled to the audio module 170 by using an I2S bus, to implement communication between the processor 110 and the audio module 170. In some embodiments, the audio module 170 may transmit an audio signal to the wireless communications module 160 by using the I2S interface, to implement a function of answering a call by using a Bluetooth headset.

The PCM interface may also be used for audio communication, to sample, quantize, and encode an analog signal. In some embodiments, the audio module 170 may be coupled to the wireless communications module 160 by using the PCM bus interface. In some embodiments, the audio module 170 may also transmit an audio signal to the wireless communications module 160 by using the PCM interface, to implement a function of answering a call by using a Bluetooth headset. Both the I2S interface and the PCM interface may be used for audio communication.

The UART interface is a universal serial data bus used for asynchronous communication. The bus may be a two-way communications bus. The bus converts to-be-transmitted data between serial communication and parallel communication. In some embodiments, the UART interface is usually configured to connect the processor 110 to the wireless communications module 160. For example, the processor 110 communicates with a Bluetooth module in the wireless communications module 160 by using the UART interface, to implement a Bluetooth function. In some embodiments, the audio module 170 may transmit an audio signal to the wireless communications module 160 by using the UART interface, to implement a function of playing music by using a Bluetooth headset.

The MIPI interface may be configured to connect the processor 110 to a peripheral device such as the display screen 194 or the camera 193. The MIPI interface includes a camera serial interface (CSI), a display serial interface (DSI), and the like. In some embodiments, the processor 110 communicates with the camera 193 by using the CSI interface, to implement a photographing function of the terminal 100; and the processor 110 communicates with the display screen 194 by using the DSI interface, to implement a display function of the terminal 100.

The GPIO interface may be configured by using software. The GPIO interface may be configured as a control signal interface, or may be configured as a data signal interface. In some embodiments, the GPIO interface may be configured to connect the processor 110 to the camera 193, the display screen 194, the wireless communications module 160, the audio module 170, the sensor module 180, or the like. The GPIO interface may be alternatively configured as an I2C interface, an I2S interface, a UART interface, an MIPI interface, or the like.

The USB interface 130 is an interface that complies with a USB standard specification, and may be specifically a mini USB interface, a micro USB interface, a USB Type C interface, or the like. The USB interface 130 may be configured to connect to a charger to charge the terminal 100, or may be configured to transmit data between the terminal 100 and a peripheral device, or may be configured to connect to a headset to play an audio by using the headset. Alternatively, the interface may be configured to connect to another terminal, for example, an AR device.

It can be understood that an interface connection relationship between the modules shown in this embodiment of this application is merely an example for description, and does not constitute a limitation on a structure of the terminal 100. In some other embodiments of this application, the terminal 100 may alternatively use an interface connection manner different from that in the foregoing embodiment, or use a combination of a plurality of interface connection manners.

The charging management module 140 is configured to receive charging input from a charger. The charger may be a wireless charger, or may be a wired charger. In some embodiments of wired charging, the charging management module 140 may receive charging input from a wired charger by using the USB interface 130. In some embodiments of wireless charging, the charging management module 140 may receive wireless charging input by using a wireless charging coil of the terminal 100. When charging the battery 142, the charging management module 140 may further supply power to the terminal by using the power management module 141.

The power management module 141 is configured to connect to the battery 142, the charging management module 140, and the processor 110. The power management module 141 receives input from the battery 142 and/or the charging management module 140, and supplies power to the processor 110, the internal memory 121, the display screen 194, the camera 193, the wireless communications module 160, and the like. The power management module 141 may be further configured to monitor parameters such as a battery capacity, a quantity of battery cycles, and a battery health status (electric leakage and impedance). In some other embodiments, the power management module 141 may be alternatively disposed in the processor 110. In some other embodiments, the power management module 141 and the charging management module 140 may be alternatively disposed in a same device.

A wireless communication function of the terminal 100 may be implemented by the antenna 1, the antenna 2, the mobile communications module 150, the wireless communications module 160, the modem processor, the baseband processor, and the like.

The antenna 1 and the antenna 2 are configured to transmit and receive electromagnetic wave signals. Each antenna in the terminal 100 may be configured to cover one or more communication frequency bands. Different antennas may be multiplexed to improve antenna utilization. For example, the antenna 1 may be multiplexed as a diversity antenna of a wireless local area network. In some other embodiments, an antenna may be used in combination with a tuning switch.

The mobile communications module 150 may provide a solution that is applied to the terminal 100 and that includes wireless communications technologies such as 2G, 3G, 4G, and 5G. The mobile communications module 150 may include at least one filter, a switch, a power amplifier, a low noise amplifier (LNA), and the like. The mobile communications module 150 may receive an electromagnetic wave by using the antenna 1, perform processing such as filtering and amplification on the received electromagnetic wave, and transmit a processed electromagnetic wave to the modem processor for demodulation. The mobile communications module 150 may further amplify a signal modulated by the modem processor, and convert an amplified signal into an electromagnetic wave and radiate the electromagnetic wave by using the antenna 1. In some embodiments, at least some functional modules of the mobile communications module 150 may be disposed in the processor 110. In some embodiments, at least some functional modules of the mobile communications module 150 and at least some modules of the processor 110 may be disposed in a same device.

The modem processor may include a modulator and a demodulator. The modulator is configured to modulate a to-be-sent low-frequency baseband signal into an intermediate- or high-frequency signal. The demodulator is configured to demodulate a received electromagnetic wave signal into a low-frequency baseband signal. Then the demodulator transmits the low-frequency baseband signal obtained through demodulation to the baseband processor for processing. The low-frequency baseband signal is processed by the baseband processor, and a processed signal is transmitted to the application processor. The application processor outputs a sound signal by using an audio device (not limited to the speaker 170-1, the receiver 170-2, and the like), or displays an image or a video by using the display screen 194. In some embodiments, the modem processor may be an independent device. In some other embodiments, the modem processor may be independent of the processor 110, and is disposed in a same device with the mobile communications module 150 or another functional module.

The wireless communications module 160 may provide a solution that is applied to the terminal 100 and that includes wireless communications technologies such as a wireless local area network (WLAN) (e.g., a wireless fidelity (Wi-Fi) network), Bluetooth (BT), a global navigation satellite system (GNSS), frequency modulation (FM), a near field communication (NFC) technology, and an infrared (IR) technology. The wireless communications module 160 may be one or more devices that integrate at least one communications processing module. The wireless communications module 160 receives an electromagnetic wave by using the antenna 2, performs frequency modulation and filtering processing on an electromagnetic wave signal, and sends a processed signal to the processor 110. The wireless communications module 160 may further receive a to-be-sent signal from the processor 110, perform frequency modulation and amplification on the signal, and convert a processed signal into an electromagnetic wave and radiate the electromagnetic wave by using the antenna 2.

In some embodiments, the antenna 1 of the terminal 100 is coupled to the mobile communications module 150, and the antenna 2 is coupled to the wireless communications module 160, so that the terminal 100 may communicate with a network and another device by using a wireless communications technology. The wireless communications technology may include a global system for mobile communications (GSM), a general packet radio service (GPRS), code division multiple access (CDMA), wideband code division multiple access (WCDMA), time division-synchronous code division multiple access (TD-SCDMA), long term evolution (LTE), BT, a GNSS, a WLAN, NFC, FM, an IR technology, and/or the like. The GNSS may include a global positioning system (GPS), a global navigation satellite system (GLONASS), a BeiDou navigation satellite system (BDS), a quasi-zenith satellite system (QZSS), and/or a satellite-based augmentation system (SBAS).

The terminal 100 implements a display function by using the GPU, the display screen 194, the application processor, and the like. The GPU is a microprocessor for image processing, and is connected to the display screen 194 and the application processor. The GPU is configured to perform mathematical and geometric calculation, and is used for graphics rendering. The processor 110 may include one or more GPUs that execute a program instruction to generate or change display information.

The display screen 194 is configured to display an image, a video, and the like. The display screen 194 includes a display panel. The display panel may be a liquid crystal display (LCD), an organic light-emitting diode (OLED), an active-matrix organic light-emitting diode (AMOLED), a flexible light-emitting diode (FLED), a mini LED, a micro LED, a micro OLED, a quantum dot light-emitting diodes (QLED), or the like. In some embodiments, the terminal 100 may include one or N display screens 194, where N is a positive integer greater than 1.

The terminal 100 may implement a photographing function by using the ISP, the camera 193, the video codec, the GPU, the display screen 194, the application processor, and the like.

The ISP is configured to process data fed back by the camera 193. For example, during photographing, a shutter is opened, light is transmitted to a photosensitive element of the camera through a lens, an optical signal is converted into an electrical signal, and the photosensitive element of the camera transmits the electrical signal to the ISP for processing, to convert the electrical signal into an image visible to a naked eye. The ISP may further optimize noise, luminance, and complexion of the image based on an algorithm. The ISP may further optimize parameters such as exposure and color temperature of a photographing scenario. In some embodiments, the ISP may be disposed in the camera 193.

The camera 193 is configured to capture a static image or a video. An optical image is generated for an object by using the lens, and the optical image is projected to the photosensitive element. The photosensitive element may be a charge coupled device (CCD) or a complementary metal-oxide-semiconductor (CMOS) phototransistor. The photosensitive element converts an optical signal into an electrical signal, and then transmits the electrical signal to the ISP to convert the electrical signal into a digital image signal. The ISP outputs the digital image signal to the DSP for processing. The DSP converts the digital image signal into a standard image signal in an RGB format, a YUV format, or the like. In some embodiments, the terminal 100 may include one or N cameras 193, where N is a positive integer greater than 1.

The digital signal processor is configured to process a digital signal. In addition to a digital image signal, the digital signal processor may further process another digital signal. For example, when the terminal 100 selects a frequency, the digital signal processor is configured to perform Fourier transformation and the like on frequency energy.

The video codec is configured to compress or decompress a digital video. The terminal 100 may support one or more types of video codecs. In this way, the terminal 100 may play or record videos in a plurality of encoding formats, for example, moving picture experts group (MPEG)-1, MPEG-2, MPEG-3, and MPEG-4.

The NPU is a neural-network (NN) computing processor. The NPU quickly processes input information with reference to a structure of a biological neural network, for example, with reference to a transfer mode between human brain neurons, and may further continuously perform self-learning. The NPU may implement applications such as intelligent cognition of the terminal 100, for example, image recognition, facial recognition, speech recognition, and text comprehension.

The external memory interface 120 may be configured to connect to an external storage card, for example, a micro SD card, to extend a storage capability of the terminal 100. The external storage card communicates with the processor 110 by using the external memory interface 120, to implement a data storage function. For example, files such as music and videos are stored in the external storage card.

The internal memory 121 may be configured to store computer executable program code, and the executable program code includes an instruction. The internal memory 121 may include a program storage area and a data storage area. The program storage area may store an operating system, an application program required by at least one function (e.g., a sound play function or an image play function), and the like. The data storage area may store data (e.g., audio data and a phone book) created in a process of using the terminal 100, and the like. In addition, the internal memory 121 may include a high-speed random access memory, or may include a nonvolatile memory, for example, at least one magnetic disk storage device, a flash storage device, or a universal flash storage (UFS). The processor 110 performs various functional applications and data processing of the terminal 100 by running an instruction stored in the internal memory 121 and/or an instruction stored in a memory disposed in the processor.

The terminal 100 may implement audio functions, for example, music playing and recording, by using the audio module 170, the speaker 170-1, the receiver 170-2, the microphone 170-3, the headset interface 170-4, the application processor, and the like.

The audio module 170 is configured to convert digital audio information into an analog audio signal for output, and is also configured to convert analog audio input into a digital audio signal. The audio module 170 may be further configured to encode and decode an audio signal. In some embodiments, the audio module 170 may be disposed in the processor 110, or some functional modules of the audio module 170 are disposed in the processor 110.

The speaker 170-1, also referred to as a “loudspeaker”, is configured to convert an audio electrical signal into a sound signal. The terminal 100 may be used to listen to music or answer a hands-free call by using the speaker 170-1.

The receiver 170-2, also referred to as an “earpiece”, is configured to convert an audio electrical signal into a sound signal. When the terminal 100 is used to answer a call or listen to voice information, the receiver 170-2 may be placed close to a human ear to listen to a voice.

The microphone 170-3, also referred to as a “mike” or a “mic”, is configured to convert a sound signal into an electrical signal. When making a call or sending voice information, a user may move a mouth close to the microphone 170-3 and make a sound, to input a sound signal into the microphone 170-3. At least one microphone 170-3 may be disposed in the terminal 100. In some other embodiments, two microphones 170-3 may be disposed in the terminal 100, to implement a noise reduction function, in addition to collecting a sound signal. In some other embodiments, three, four, or more microphones 170-3 may be alternatively disposed in the terminal 100, to collect a sound signal and reduce noise. The microphones 170-3 may further identify a sound source, implement a directional recording function, and the like.

The headset interface 170-4 is configured to connect to a wired headset. The headset interface 170-4 may be a USB interface 130, or may be a 3.5-mm open mobile terminal platform (OMTP) standard interface, or a cellular telecommunications industry association of the USA (CTIA) standard interface.

The pressure sensor 180-1 is configured to sense a pressure signal, and may convert the pressure signal into an electrical signal. In some embodiments, the pressure sensor 180-1 may be disposed in the display screen 194. There are many types of pressure sensors 180-1, for example, a resistive pressure sensor, an inductive pressure sensor, and a capacitive pressure sensor. The capacitive pressure sensor may include at least two parallel plates that have conductive materials. When a force acts on the pressure sensor 180-1, capacitance between electrodes changes. The terminal 100 determines pressure strength based on the capacitance change. When a touch operation acts on the display screen 194, the terminal 100 detects strength of the touch operation based on the pressure sensor 180-1. The terminal 100 may also calculate a touch position based on a detection signal of the pressure sensor 180-1. In some embodiments, touch operations acting on a same touch position but having different touch operation strength may correspond to different operation instructions. For example, when a touch operation whose touch operation strength is less than a first pressure threshold acts on an icon of an SMS application, an instruction for viewing an SMS message is executed; or when a touch operation whose touch operation strength is greater than or equal to the first pressure threshold acts on the icon of the SMS application, an instruction for creating an SMS message is executed.

The gyroscope sensor 180-2 may be configured to determine a motion posture of the terminal 100. In some embodiments, an angular velocity of the terminal 100 around three axes (that is, an x-axis, ay-axis, and a z-axis) may be determined by using the gyroscope sensor 180-2. The gyroscope sensor 180-2 may be used for image stabilization during photographing. For example, when the shutter is pressed, the gyroscope sensor 180-2 detects an angle at which the terminal 100 shakes, and calculates, based on the angle, a distance for which a lens module needs to compensate, so that the lens cancels the shake of the terminal 100 through reverse motion, thereby implementing image stabilization. The gyroscope sensor 180-2 may be further used in navigation and motion sensing game scenarios.

The barometric pressure sensor 180-3 is configured to measure barometric pressure. In some embodiments, the terminal 100 calculates an altitude by using a barometric pressure value measured by the barometric pressure sensor 180-3, to assist in positioning and navigation.

The magnetic sensor 180-4 includes a Hall effect sensor. The terminal 100 may detect opening/closing of a clamshell leather case by using the magnetic sensor 180-4. In some embodiments, when the terminal 100 is a clamshell phone, the terminal 100 may detect opening/closing of a clamshell based on the magnetic sensor 180-4. Further, a feature, such as automatic unlocking when the clamshell is open, is set based on a detected open/closed state of a leather case or a detected open/closed state of the clamshell.

The acceleration sensor 180-5 may detect a magnitude of an acceleration of the terminal 100 in each direction (usually, three axes). When the terminal 100 is still, a magnitude and a direction of gravity may be detected. The acceleration sensor 180-5 may be further configured to identify a posture of the terminal, and is applied to applications such as landscape/portrait mode switching and a pedometer.

The distance sensor 180-6 is configured to measure a distance. The terminal 100 may measure a distance by using an infrared or laser technology. In some embodiments, in a photographing scenario, the terminal 100 may measure a distance by using the distance sensor 180-6, to implement fast focusing.

The optical proximity sensor 180-7 may include, for example, a light emitting diode (LED) and an optical detector, for example, a photodiode. The light emitting diode may be an infrared light emitting diode. The terminal 100 emits infrared light by using the light emitting diode. The terminal 100 detects, by using the photodiode, infrared reflected light that comes from a nearby object. When detecting sufficient reflected light, the terminal 100 may determine that there is an object near the terminal 100; or when detecting insufficient reflected light, the terminal 100 may determine that there is no object near the terminal 100. The terminal 100 may detect, by using the optical proximity sensor 180-7, that a user holds the terminal 100 close to an ear for a call, to automatically turn off the screen to save power. The optical proximity sensor 180-7 may also be used for automatic screen locking or unlocking in a leather case mode or a pocket mode.

The ambient light sensor 180-11 is configured to sense luminance of ambient light. The terminal 100 may adaptively adjust luminance of the display screen 194 based on the sensed luminance of ambient light. The ambient light sensor 180-11 may also be configured to automatically adjust white balance during photographing. The ambient light sensor 180-11 may further cooperate with the optical proximity sensor 180-7 to detect whether the terminal 100 is in a pocket, to prevent an accidental touch.

The fingerprint sensor 180-8 is configured to collect a fingerprint. The terminal 100 may implement fingerprint-based unlocking, unlocking for application access, fingerprint-based photographing, fingerprint-based call answering, and the like by using a collected fingerprint characteristic.

The temperature sensor 180-9 is configured to detect temperature. In some embodiments, the terminal 100 executes a temperature processing policy by using the temperature detected by the temperature sensor 180-9. For example, when temperature reported by the temperature sensor 180-9 exceeds a threshold, the terminal 100 degrades performance of a processor near the temperature sensor 180-9, to reduce power consumption and implement thermal protection. In some other embodiments, when temperature is lower than another threshold, the terminal 100 heats up the battery 142 to avoid abnormal shutdown of the terminal 100 due to low temperature. In some other embodiments, when temperature is lower than still another threshold, the terminal 100 boosts an output voltage of the battery 142 to avoid abnormal shutdown due to low temperature.

The touch sensor 180-10 is also referred to as a “touch device”. The touch sensor 180-10 may be disposed in the display screen 194, and the touch sensor 180-10 and the display screen 194 form a touchscreen, which is also referred to as a “touch control screen”. The touch sensor 180-10 is configured to detect a touch operation acting on or near the touch sensor. The touch sensor may transmit the detected touch operation to the application processor, to determine a type of a touch event. Visual output related to the touch operation may be provided by using the display screen 194. In some other embodiments, the touch sensor 180-10 may be alternatively disposed on a surface of the terminal 100, and is at a position different from that of the display screen 194.

The bone conduction sensor 180-12 may obtain a vibration signal. In some embodiments, the bone conduction sensor 180-12 may obtain a vibration signal from a vibration bone of a human voice part. The bone conduction sensor 180-12 may also be in contact with a human pulse, and receive a blood pressure and pulse signal. In some embodiments, the bone conduction sensor 180-12 may be alternatively disposed in a headset to form a bone conduction headset. The audio module 170 may parse out a speech signal based on the vibration signal obtained by the bone conduction sensor 180-12 from the vibration bone of the voice part, to implement a speech function. The application processor may parse out heart rate information based on the blood pressure and pulse signal obtained by the bone conduction sensor 180-12, to implement a heart rate detection function.

The key 190 includes a power key, a volume key, or the like. The key 190 may be a mechanical key, or may be a touch key. The terminal 100 may receive key input, and generate key signal input related to user settings and function control of the terminal 100.

The motor 191 may produce a vibration prompt. The motor 191 may be configured to produce a vibration prompt for an incoming call, or may be configured to produce a vibration feedback on a touch. For example, touch operations acting on different applications (e.g., photographing and audio playing) may correspond to different vibration feedback effects. For touch operations acting on different areas on the display screen 194, the motor 191 may also correspondingly produce different vibration feedback effects. Different application scenarios (e.g., a time reminder, information receiving, an alarm clock, and a game) may also correspond to different vibration feedback effects. A touch vibration feedback effect may be further customized.

The indication device 192 may be an indicator, and may be configured to indicate a charging status and a battery level change, or may be configured to indicate a message, a missed call, a notification, or the like.

The SIM card interface 195 is configured to connect to a SIM card. The SIM card may be inserted in the SIM card interface 195 or removed from the SIM card interface 195, to implement contact with or separation from the terminal 100. The terminal 100 may support one or N SIM card interfaces, where N is a positive integer greater than 1. The SIM card interface 195 may support a nano SIM card, a micro SIM card, a SIM card, and the like. A plurality of cards may be inserted in one SIM card interface 195. The plurality of cards may be of a same type, or may be of different types. The SIM card interface 195 may also be compatible with different types of SIM cards. The SIM card interface 195 may also be compatible with an external storage card. The terminal 100 interacts with a network by using the SIM card, to implement functions such as a call and data communication. In some embodiments, the terminal 100 uses an eSIM, that is, an embedded SIM card. The eSIM card may be embedded in the terminal 100, and cannot be separated from the terminal 100. A hierarchical architecture, an event-driven architecture, a micro-core architecture, a micro-service architecture, or a cloud architecture may be used for a software system of the terminal 100. In this embodiment of this application, an Android system with a hierarchical architecture is used as an example to describe a software structure of the terminal 100.

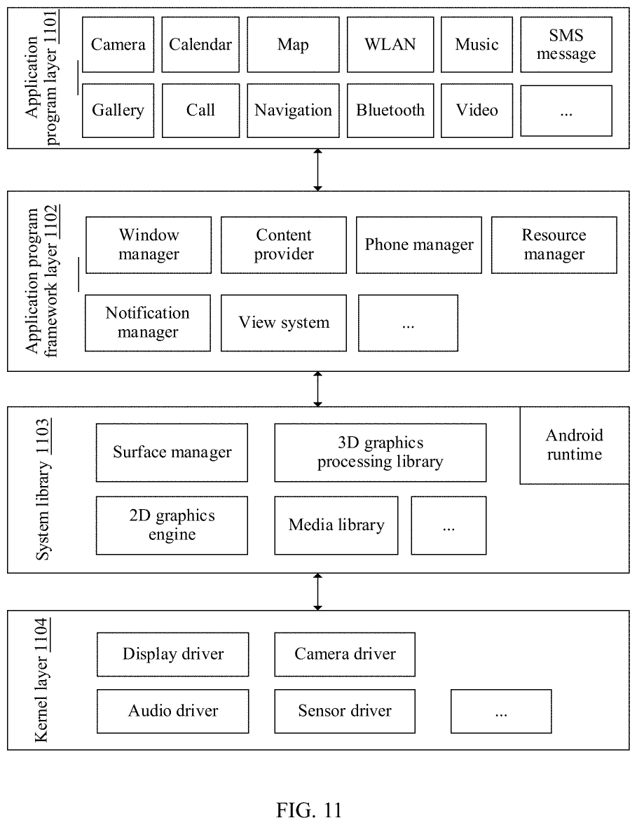

FIG. 11 is a block diagram of a software structure of a terminal 100 according to an embodiment of this application.

A hierarchical architecture divides software into several layers. Each layer has a clear role and responsibility. Layers communicate with each other by using a software interface. In some embodiments, an Android system is divided into four layers from top to bottom: an application program layer 1101, an application program framework layer 1102, Android runtime (Android runtime) and a system library 1103, and a kernel layer 1104.

The application program layer 1101 may include a series of application program packages.

As shown in FIG. 11, an application program package may include application programs such as a camera, a gallery, a calendar, a call, a map, navigation, a WLAN, Bluetooth, music, a video, and an SMS message.

The application program framework layer 1102 provides an application programming interface (API) and an application programming framework for an application program at the application program layer 1101. The application program framework layer 1102 includes some predefined functions.

As shown in FIG. 11, the application program framework layer 1102 may include a window manager, a content provider, a view system, a phone manager, a resource manager, a notification manager, and the like.

The window manager is configured to manage a window program. The window manager may obtain a size of the display screen, determine whether there is a status bar, lock the screen, take a screenshot, and the like.

The content provider is configured to store and obtain data, and make the data accessible to an application program. The data may include a video, an image, an audio, a call made and a call answered, a browsing history and a bookmark, a phone book, and the like.

The view system includes a visual control, for example, a word display control or a picture display control. The view system may be configured to build an application program. A display interface may include one or more views. For example, a display interface including an SMS notification icon may include a word display view and a picture display view.

The phone manager is configured to provide a communication function of the terminal 100. For example, the phone manager manages a call status (including answering, hanging up, and the like).

The resource manager provides various resources for an application program, for example, a localized string, an icon, a picture, a layout file, and a video file.

The notification manager enables an application program to display notification information in a status bar, and may be configured to deliver a notification-type message. The message may automatically disappear after short display, without user interaction. For example, the notification manager is configured to notify download completion or give a message reminder. Alternatively, the notification manager may be a notification that appears in a top status bar of the system in a form of a chart or a scroll-bar text, for example, a notification for an application program running at the background; or may be a notification that appears on the screen in a form of a dialog window. For example, text information is prompted in the status bar, a prompt tone is played, the terminal vibrates, or an indicator blinks.

The Android runtime includes a core library and a virtual machine. The Android runtime is responsible for scheduling and managing the Android system.

The core library includes two parts: a functionality that needs to be invoked for Java programming language, and an Android core library.

The application program layer 1101 and the application program framework layer 1102 run in the virtual machine. The virtual machine executes Java files at the application program layer 1101 and the application program framework layer 1102 as binary files. The virtual machine is configured to perform functions such as managing a life cycle of an object, managing a stack, managing a thread, managing security and an exception, and collecting garbage.

The system library 1103 may include a plurality of functional modules, for example, a surface manager, media libraries, a 3D graphics processing library (e.g., OpenGL ES), and a 2D graphics engine (e.g., SGL).

The surface manager is configured to manage a display subsystem, and provide 2D and 3D layer fusion for a plurality of application programs.

The media library supports playback and recording in a plurality of common audio and video formats, static image files, and the like. The media library may support a plurality of audio and video encoding formats, for example, MPEG-4, H.264, MP3, AAC, AMR, JPG, and PNG.

The 3D graphics processing library is configured to implement 3D graphics drawing, image rendering, synthesis, layer processing, and the like.

The 2D graphics engine is a drawing engine for 2D drawing.

The kernel layer 1104 is a layer between hardware and software. The kernel layer 1104 includes at least a display driver, a camera driver, an audio driver, and a sensor driver.

The following describes an example of a working process of software and hardware of the terminal 100 with reference to an interface display scenario shown in FIG. 7A-7B.

In a process in which the terminal 100 displays an interface 701, as shown in FIG. 7A, on the display screen 194, when a user touches prompt information “Go to an e-commerce application A to view a comment?”, the touch sensor 180-10 receives the touch operation, and a corresponding hardware interrupt is sent to the kernel layer 1104. The kernel layer 1104 processes the touch operation into an original input event (including information such as touch coordinates and a time stamp of the touch operation). The original input event is stored at the kernel layer 1104. The application program framework layer 1102 obtains the original input event from the kernel layer 1104, and identifies a control corresponding to the input event. For example, the touch operation is a tap operation, and a control corresponding to the tap operation is a control including the prompt information. An e-commerce application invokes an interface of the application program framework layer 1102 to start the e-commerce application and further generate an interface of the e-commerce application. For example, the interface 711 as shown in FIG. 7B is generated. The interface 711 of the e-commerce application is displayed on the display screen 194.

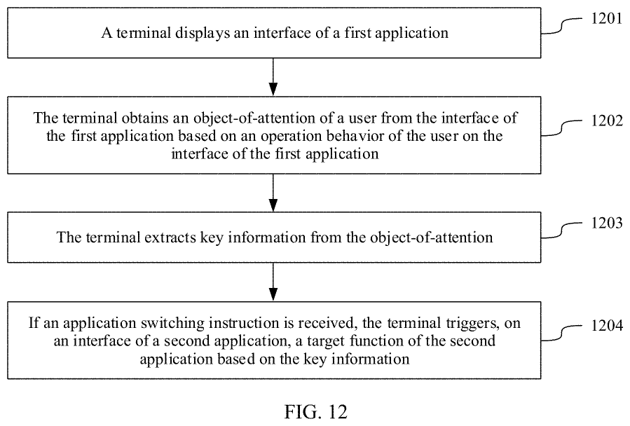

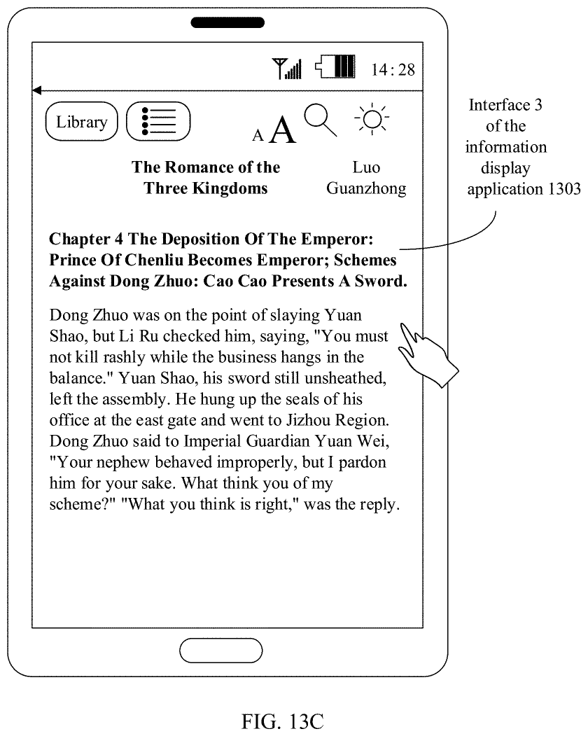

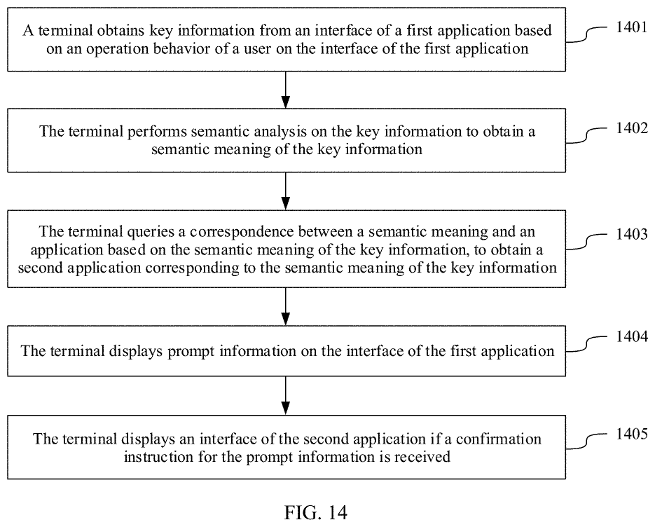

FIG. 10 describes the structure of the terminal 100. For a method for displaying an interface by the terminal 100, refer to an embodiment of FIG. 12 and an embodiment of FIG. 14.

FIG. 12 is a flowchart of an interface display method according to an embodiment of this application. As shown in FIG. 12, the method includes step 1201 to step 1204 that are performed by a terminal.

Step 1201: The terminal displays an interface of a first application.

The terminal may switch between a plurality of applications. For ease of description, a switched-from application is referred to as a first application, and a switched-to application is referred to as a second application.

The interface of the first application may include key information, and the key information may be recommendation information about a resource. From a perspective of content of the recommendation information, the recommendation information about the resource may be a comment that a user gives on the resource based on use experience after using the resource. For example, the resource is food. The recommendation information about the resource may be a user's comment on the food after the user tastes the food. For example, referring to FIG. 2A, a resource is “XX iron-rich, fragrant oatmeal with red dates”, and the interface 201 includes a recommendation article published by a user after the user tastes “XX iron-rich, fragrant oatmeal with red dates”. For example, the resource is a site. The recommendation information about the resource may be an introduction to the site. For example, referring to FIG. 3A, a resource is “Hengshan”, and the interface 301 shows an introduction to “Hengshan”. For example, the resource is a book. The recommendation information about the resource may be a user's comment on the book after the user reads the book. For example, referring to FIG. 4A, a resource is “Children Who Grow up with Story Books”, and the interface 401 shows a user's comment on “Children Who Grow up with Story Books” after the user reads the book. From a perspective of a source of the recommendation information, the recommendation information about the resource may be a message published by a user of the first application. For example, the first application is an instant messaging application. The recommendation information about the resource may be a message in a social group established by using the instant messaging application, for example, the message may be a message in a group chat; the recommendation information about the resource may be a message between different users between whom a user relationship chain is established by using the instant messaging application, for example, the message may be a message sent by a user to a friend, or may be a message sent by a friend to a user; or the recommendation information about the resource may be a message published by using a public social network identifier established by the instant messaging application, for example, the message may be a message published by an official account subscribed to by a user. For example, the first application is a community application. The recommendation information about the resource may be a post, a log, a blog, a microblog, or the like published by using the community application. For example, the first application is a game application. The recommendation information about the resource may be a message sent by a virtual object to another virtual object during a game. From a perspective of a type of the recommendation information, the recommendation information about the resource includes but is not limited to any one or a combination of a word, a picture, a voice, and a video.

Step 1202: The terminal obtains an object-of-attention of a user from the interface of the first application based on an operation behavior of the user on the interface of the first application.

In a process in which the terminal displays the interface of the first application, the user may perform the operation behavior, and the terminal may capture the operation behavior of the user, and obtain the object-of-attention of the user from the interface of the first application based on the operation behavior. The operation behavior may include at least one of a manual behavior and an eye movement behavior. The manual behavior may be a behavior that the user performs an operation on an interface with a hand. For example, the manual behavior may be a touch behavior of touching an interface on a touchscreen. For another example, the manual behavior may be a behavior of performing an operation on an interface of a screen by using an external device such as a mouse. The eye movement behavior may be a behavior that the user browses an interface with an eye. The object-of-attention is content that is on the interface of the first application and to which the user pays attention. The object-of-attention includes but is not limited to any one or a combination of a word, a picture, a voice, and a video. The object-of-attention includes key information.

For example, step 1202 includes the following steps 1 and 2.

Step 1: Identify an attention degree of at least one piece of content on the interface of the first application based on the operation behavior of the user on the interface of the first application.

The attention degree indicates a degree of attention that the user pays to the content. In some possible embodiments, an implementation of step 1 includes but is not limited to any one or a combination of the following implementations 1 to 8.

Implementation 1: The terminal identifies a first attention degree of the at least one piece of content based on a selection operation of the user on the interface of the first application.

A first attention degree of each piece of content is used to indicate whether the user triggers a selection operation on the content. For example, the first attention degree may indicate that the user triggers a selection operation on the content or the user does not trigger a selection operation on the content. The first attention degree may include a first value and a second value. The first value indicates that the user triggers a selection operation on the content, and the second value indicates that the user does not trigger a selection operation on the content. The first value and the second value may be any two different values. For example, the first value is 1, and the second value is 0.

Implementation 2: The terminal identifies a second attention degree of the at least one piece of content based on a saving operation of the user on the interface of the first application. A second attention degree of each piece of content is used to indicate whether the user triggers a saving operation on the content.

For example, the second attention degree may indicate that the user triggers a saving operation on the content or the user does not trigger a saving operation on the content. The second attention degree may include a first value and a second value. The first value indicates that the user triggers a saving operation on the content, and the second value indicates that the user does not trigger a saving operation on the content. The first value and the second value may be any two different values. For example, the first value is 1, and the second value is 0.

Implementation 3: The terminal identifies a third attention degree of the at least one piece of content based on a screenshot operation of the user on the interface of the first application. A third attention degree of each piece of content is used to indicate whether the content is in a screenshot.

The screenshot operation includes but is not limited to a long screenshot, a scrolling screenshot, capturing a window currently at the front-most (e.g., the foreground) on an interface, capturing a selected area on an interface, and the like. The third attention degree may include a first value and a second value. The first value indicates that the content is in the screenshot, and the second value indicates that the content is not in the screenshot.

Implementation 4: The terminal identifies a fourth attention degree of the at least one piece of content based on a publishing operation of the user on the interface of the first application.

A fourth attention degree of each piece of content is used to indicate whether the user publishes the content. The fourth attention degree may include a first value and a second value. The first value indicates that the user publishes the content, and the second value indicates that the user does not publish the content. The user may trigger a publishing operation on the interface of the first application, to publish some content on the interface of the first application. In this case, the terminal receives a publishing instruction, to identify the fourth attention degree of each piece of content.

Implementation 5: The terminal detects, by using a camera, duration in which sight of the user stays on each piece of content on the interface of the first application, and uses the duration as a fifth attention degree of the content.

The fifth attention degree of each piece of content is the duration in which the sight of the user stays on the content. For example, the duration may be 10 seconds or 20 seconds. The terminal may divide the interface of the first application into a plurality of pieces of content, and each piece of content may be an entry on the interface. For each of the plurality of pieces of content, the terminal may detect, by using the camera, duration in which the sight of the user stays on the content, and use the duration as a fifth attention degree of the content.

In an example scenario, if the interface of the first application is an article thumbnail list, the terminal may use each article thumbnail in the article thumbnail list as one piece of content. The terminal may detect, by using the camera, duration in which the sight stays on each article thumbnail, and use the duration as a fifth attention degree of the article thumbnail.

In an example scenario, if the interface of the first application is a chat interface, the terminal may use each session message on the chat interface as one piece of content. The terminal may detect, by using the camera, duration in which the sight stays on each session message, and use the duration as a fifth attention degree of the session message.

In an example scenario, if the interface of the first application is a commodity recommendation interface, the terminal may use each piece of recommendation information on the commodity recommendation interface as one piece of content. The terminal may detect, by using the camera, duration in which the sight stays on each piece of recommendation information, and use the duration as a fifth attention degree of the recommendation information.

Implementation 6: The terminal detects a sliding speed of the user for each piece of content on the interface of the first application, and uses the sliding speed as a sixth attention degree of the content.

The sixth attention degree of each piece of content is the sliding speed of the user for the content. The terminal may divide the interface of the first application into a plurality of pieces of content, and each piece of content may be an entry on the interface. For each of the plurality of pieces of content, the terminal may detect a sliding speed of the user for the content, and use the sliding speed as a sixth attention degree of the content.

Implementation 7: The terminal obtains a browsing speed for the at least one piece of content based on a browsing behavior of the user on the interface of the first application, and uses the browsing speed as a seventh attention degree of the at least one piece of content.

A seventh attention degree of each piece of content is a browsing speed of the user for the content. For each piece of content on the interface of the first application, the terminal may obtain a quantity of characters of the content and display duration of the content. The terminal may detect a browsing speed of the user based on the quantity of characters of the content and the display duration of the content, and use the browsing speed as a seventh attention degree of the content. The display duration of the content may be duration from a time point at which the content starts to be displayed to a time point at which a page flip instruction is received on the content. The terminal may obtain a ratio of the quantity of characters of the content to the display duration of the content, and use the ratio as the seventh attention degree. For example, assuming that the interface of the first application includes 47 characters and the display duration is 44 seconds, a reading speed=47/44=1.1, that is, 1.1 characters are read per second, and the seventh attention degree is 1.1, where/indicates division.

A manner of obtaining a browsing speed threshold includes but is not limited to one or a combination of the following implementations (7.1) to (7.3).

Implementation (7.1): The terminal invokes an interface of an information display application to obtain a browsing speed threshold provided by the information display application.

The information display application may be any application that can display information. For example, the information display application may be a reading application, or may be an instant messaging application, or may be an application that can publish an article by using a public social network identifier. The information display application may provide the browsing speed threshold. The terminal may invoke the interface of the information display application to send a browsing speed threshold obtaining request to the information display application. The information display application receives the browsing speed threshold obtaining request by using the interface, and returns the browsing speed threshold to the terminal by using the interface. In this case, the terminal may receive the browsing speed threshold sent by the information display application.

Implementation (7.2): The terminal obtains a browsing speed threshold based on a plurality of historical browsing speeds of the user. A manner of obtaining a historical browsing speed includes but is not limited to at least one of an implementation (7.2.1) and an implementation (7.2.2).

Implementation (7.2.1): When displaying any interface, the terminal obtains a browsing speed for the interface based on a quantity of characters on the interface and display duration of the interface, and records the browsing speed for the interface as the historical browsing speed.

During historical running, the terminal may record a historical browsing speed each time any interface is displayed. For example, a historical browsing speed field may be set in a historical run log. After display of any interface ends, a browsing speed for the interface is written into the historical browsing speed field, to record the browsing speed in a current display process. In this way, a historically displayed interface may be considered as a sample of a browsing speed threshold. As time goes by, a quantity of times of displaying an interface by the terminal increases, so that a large quantity of historical browsing speeds can be recorded.

Optionally, the terminal may determine whether a currently displayed interface is an interface of an information display application, and when the interface of the information display application is displayed, obtain a browsing speed for the interface of the information display application. In an example scenario, in a process in which the terminal runs a reading application, each time the terminal displays any interface of the reading application, the terminal collects a quantity of characters on the interface and display duration of the interface, and obtains a ratio of the quantity of characters to the display duration, to obtain a browsing speed for a single interface.

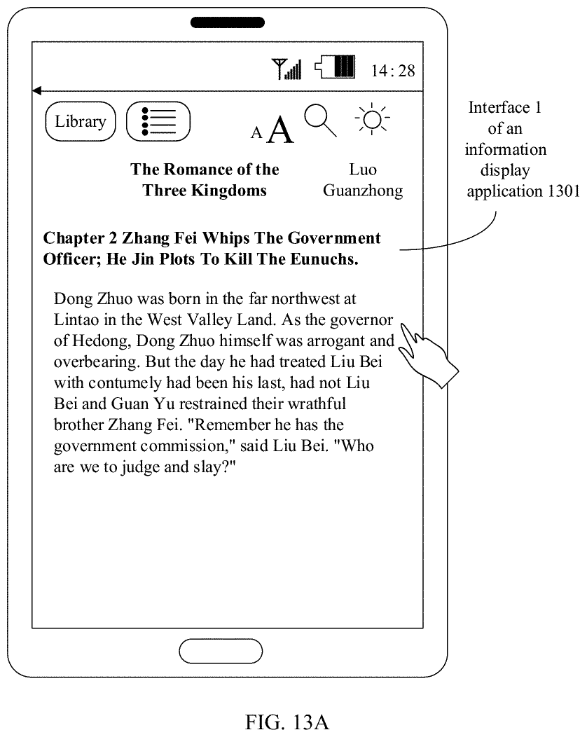

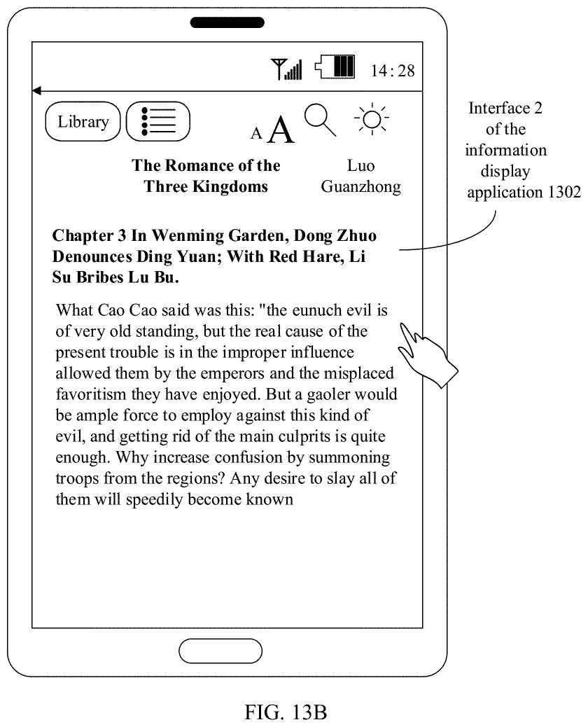

For example, referring to FIG. 13A, it is assumed that in a process in which the user uses a reading application, the terminal displays an interface 1301, a quantity of characters on the interface 1301 is 109, and display duration of the interface 1301 is 44 seconds. In this case, the terminal obtains a reading speed for the interface 1301: 109/44=2.47, and therefore the terminal records a historical browsing speed 1 as reading 2.47 characters per second. Likewise, as shown in FIG. 13B, the terminal displays an interface 1302, a quantity of characters on the interface 1302 is 73, and display duration of the interface 1302 is 79 seconds. In this case, the terminal obtains a reading speed for the interface 1302: 73/71=0.9, and therefore the terminal records a historical browsing speed 2 as reading 0.9 characters per second. Likewise, as shown in FIG. 13C, the terminal displays an interface 1303, a quantity of characters on the interface 1303 is 93, and display duration of the interface 1303 is 70 seconds. In this case, the terminal obtains a reading speed for the interface 1303: 93/70=1.16, and therefore the terminal records a historical browsing speed 3 as reading 1.16 characters per second.

Implementation (7.2.2): The terminal reads, from a historical run log, a quantity of characters on a historically displayed interface and display duration of the interface, and obtains a historical browsing speed based on the quantity of characters on the interface and the display duration of the interface.

During historical running, each time any interface is displayed, the terminal may write a quantity of characters on the interface and display duration of the interface into the historical run log. When a historical browsing speed needs to be obtained, the terminal reads, from the historical run log, a quantity of characters on a historically displayed interface and display duration of the interface, to calculate the historical browsing speed.

A manner of obtaining the browsing speed threshold based on the historical browsing speed includes at least one of an implementation (7.2.2.1) and an implementation (7.2.2.2).

Implementation (7.2.2.1): The terminal obtains an average value of a plurality of historical browsing speeds, and uses the average value of the plurality of historical browsing speeds as the browsing speed threshold. For example, it is assumed that a historical browsing speed 1 is reading 1.1 characters per second, a historical browsing speed 2 is reading 0.9 characters per second, and a historical browsing speed 3 is reading 0.7 characters per second. In this case, the browsing speed threshold=(the historical browsing speed 1+the historical browsing speed 2+the historical browsing speed 3)/3=(1.1+0.9+0.7)/3=0.9, that is, 0.9 characters are read per second.

Implementation (7.2.2.2): The terminal obtains a weighted average value of a plurality of historical browsing speeds, and uses the weighted average value of the plurality of historical browsing speeds as the browsing speed threshold. A weight of each historical browsing speed may be set according to a requirement or based on experience or an experiment. For example, a weight of a historical browsing speed for any interface may be determined based on a display time point of the interface. A later display time point of the interface may indicate a larger weight of the historical browsing speed for the interface. This ensures that a weight of a historical browsing speed of the user in recent days increases, and ensures timeliness and accuracy of the browsing speed threshold. For example, referring to FIGS. 131-13C, it is assumed that a time sequence for displaying an interface 1301, an interface 1302, and an interface 1303 is as follows: The interface 1301 is first displayed, then the interface 1302 is displayed, and then the interface 1303 is displayed. In this case, a weight of a historical browsing speed for the interface 1301 is the largest, a weight of a historical browsing speed for the interface 1302 is the second largest, and a weight of a historical browsing speed for the interface 1303 is the smallest.

Implementation (7.3): The terminal reads a pre-stored browsing speed threshold. For example, the browsing speed threshold may be preset in an operating system of the terminal. For example, an average value of browsing speeds of a plurality of sample users may be collected, and the average value is preset in the operating system of the terminal as the browsing speed threshold.

Implementation 8: The terminal identifies an eighth attention degree of the at least one piece of content based on an interaction behavior of the user on the interface of the first application.

In a process in which the interface of the first application is displayed, the user may trigger an interaction behavior on some content on the interface. In this case, the terminal receives an interaction instruction, to identify an eighth attention degree of each piece of content. The interaction behavior includes at least one of a like behavior, a thanks behavior, a sharing behavior, a favorites behavior, and a comment behavior. The like behavior may be triggered by a like operation of the user. The thanks behavior may be triggered by a thanks operation of the user. The sharing behavior may be triggered by a sharing operation of the user. The favorites behavior may be triggered by a favorites operation of the user. The comment behavior may be triggered by a comment operation of the user.

The eighth attention degree of each piece of content is used to indicate whether the user triggers an interaction behavior on the content. For example, the eighth attention degree may indicate that the user triggers an interaction behavior on the content or the user does not trigger an interaction behavior on the content. The eighth attention degree may include a first value and a second value. The first value indicates that the user triggers an interaction behavior on the content, and the second value indicates that the user does not trigger an interaction behavior on the content.

Using the like behavior as an example, the interface of the first application may include a short video list. When the user performs a like operation on any short video, the terminal may receive a like behavior on the short video, and set an eighth attention degree of the short video to the first value.

Step 2: The terminal selects, from the at least one piece of content, content whose attention degree meets a preset condition, and uses the content as the object-of-attention.

The terminal may determine, based on an attention degree of each piece of content, whether the attention degree of the content meets the preset condition, and use the content as the object-of-attention if the attention degree of the content meets the preset condition. In some possible embodiments, an implementation of step 2 includes but is not limited to any one or a combination of the following implementations 1 to 8.

Implementation 1: The terminal selects, from the at least one piece of content based on the first attention degree of the at least one piece of content, content whose first attention degree meets a preset condition, and uses the content as the object-of-attention.

Corresponding to the implementation 1 in step 1, the terminal may determine whether the first attention degree of each piece of content is the first value, select, from the at least one piece of content, content whose first attention degree is the first value, and use the content as the object-of-attention. In this manner, content on which the user triggers a selection operation is used as the object-of-attention. If the selection operation is a select-all operation, the first attention degree of all the at least one piece of content may be the first value, and all content on the interface of the first application is used as the object-of-attention. If the selection operation is a segment selection operation, a first attention degree of some content is the first value, and a first attention degree of some content is the second value. In this case, some content on the interface of the first application is used as the object-of-attention. For example, referring to FIG. 3B, if the user selects a word “Hengshan”, the terminal obtains “Hengshan”, and uses “Hengshan” as the object-of-attention of the user.

Implementation 2: The terminal selects, from the at least one piece of content based on the second attention degree of the at least one piece of content, content whose second attention degree meets a preset condition, and uses the content as the object-of-attention.

Corresponding to the implementation 2 in step 1, the terminal may determine whether the second attention degree of each piece of content is the first value, select, from the at least one piece of content, content whose second attention degree is the first value, and use the content as the object-of-attention. In this case, content on which the user triggers a saving operation is used as the object-of-attention. For example, referring to FIG. 2A, if the user saves a picture of “XX iron-rich, fragrant oatmeal with red dates”, the terminal obtains the picture of “XX iron-rich, fragrant oatmeal with red dates”, and uses the picture of “XX iron-rich, fragrant oatmeal with red dates” as the object-of-attention.

Implementation 3: The terminal selects, from the at least one piece of content based on the third attention degree of the at least one piece of content, content whose third attention degree meets a preset condition, and uses the content as the object-of-attention.

Corresponding to the implementation 3 in step 1, the terminal may determine whether the third attention degree of each piece of content is the first value, select, from the at least one piece of content, content whose third attention degree is the first value, and use the content as the object-of-attention. In this case, the terminal uses content in a screenshot as the object-of-attention.

Implementation 4: The terminal selects, from the at least one piece of content based on the fourth attention degree of the at least one piece of content, content whose fourth attention degree meets a preset condition, and uses the content as the object-of-attention.

Corresponding to the implementation 4 in step 1, the terminal may determine whether the fourth attention degree of each piece of content is the first value, select, from the at least one piece of content, content whose fourth attention degree is the first value, and use the content as the object-of-attention. For example, referring to FIG. 2A, if the user clicks/taps a comment option and publishes a comment on the recommendation article: “The oatmeal looks good. I like it.”, a publishing instruction is triggered. In this case, a fourth attention degree of the sentence “The oatmeal looks good. I like it.” is the first value, and the terminal obtains the sentence and uses the sentence as the object-of-attention.

Implementation 5: The terminal selects, from the at least one piece of content based on the fifth attention degree of the at least one piece of content, content whose fifth attention degree meets a preset condition, and uses the content as the object-of-attention.

Corresponding to the implementation 5 in step 1, the terminal may sort fifth attention degrees of a plurality of pieces of content in descending order, and the terminal may select, from a sorting result, content with a largest fifth attention degree as the object-of-attention. In this manner, content on which the sight of the user stays for a longest time is used as the object-of-attention. For example, the terminal may select, as the object-of-attention, an article thumbnail on which the sight stays for a longest time; the terminal may select, as the object-of-attention, a session message on which the sight stays for a longest time; or the terminal may select, as the object-of-attention, recommendation information on which the sight stays for a longest time.

Implementation 6: The terminal selects, from the at least one piece of content based on the sixth attention degree of the at least one piece of content, content whose sixth attention degree meets a preset condition, and uses the content as the object-of-attention.

Corresponding to the implementation 6 in step 1, the terminal may sort sixth attention degrees of a plurality of pieces of content in ascending order, and the terminal may select, from a sorting result, content with a smallest sixth attention degree as the object-of-attention. In this case, the terminal uses content with a lowest sliding speed as the object-of-attention.

Implementation 7: The terminal selects, from the at least one piece of content based on the seventh attention degree of the at least one piece of content, content whose seventh attention degree meets a preset condition, and uses the content as the object-of-attention.

Corresponding to the implementation 7 in step 1, the terminal may determine whether the seventh attention degree of each piece of content is less than the browsing speed threshold. When the seventh attention degree is less than the browsing speed threshold, the content is used as the object-of-attention. In this case, the terminal uses, as the object-of-attention, content whose browsing speed is less than the browsing speed threshold, that is, content read by the user comparatively slowly.

Implementation 8: The terminal selects, from the at least one piece of content based on the eighth attention degree of the at least one piece of content, content whose eighth attention degree meets a preset condition, and uses the content as the object-of-attention.

Corresponding to the implementation 8 in step 1, the terminal may determine whether the eighth attention degree of each piece of content is the first value, select, from the at least one piece of content, content whose eighth attention degree is the first value, and use the content as the object-of-attention. In this case, the terminal uses, as the object-of-attention, content on which the user triggers an interaction behavior.

Step 1203: The terminal extracts the key information from the object-of-attention.

For example, step 1203 includes but is not limited to any one or a combination of the following implementations 1 to 6.

Implementation 1: If the object-of-attention includes a text, a keyword in the text is extracted as the key information.

The terminal may invoke an interface of a natural language analysis platform to send the text to the natural language analysis platform. The natural language analysis platform extracts the keyword in the text and sends the keyword to the terminal. The terminal may receive the keyword sent by the natural language analysis platform. Alternatively, the terminal may have a built-in natural language analysis function, and the terminal extracts the keyword in the text.

Implementation 2: If the object-of-attention includes a picture, image analysis is performed on the picture to obtain the key information.

The terminal may invoke an interface of an image analysis platform to send the picture to the image analysis platform. The image analysis platform performs image analysis on the object-of-attention to obtain the key information, and sends the key information to the terminal. The terminal may receive the key information sent by the image analysis platform. Alternatively, the terminal may have a built-in image analysis function, and the terminal performs image analysis on the object-of-attention.

In some possible embodiments, the key information may be a character in a picture, and the terminal may perform character recognition on the picture to obtain the key information. The character recognition may be implemented by using an optical character recognition (OCR) technology. For example, assuming that the object-of-attention is an image of a packaging bag of “XX iron-rich, fragrant oatmeal with red dates”, the key information may be characters such as “oatmeal” printed on the packaging bag.

Implementation 3: If the object-of-attention includes a title, the title in the object-of-attention is extracted as the key information.

The implementation 3 includes but is not limited to at least one of an implementation (3.1) to an implementation (3.3).

Implementation (3.1): The terminal obtains a word at a preset position in content on the interface of the first application, and uses the word as a title of the content.

The terminal may determine, based on a position of a word on the interface of the first application, whether the word is the title. Usually, the title is at a front position on the interface. Therefore, the terminal may pre-store the preset position, and use the word at the preset position in the content on the interface of the first application as the title. The preset position may be a front-most position on the interface.

Implementation (3.2): The terminal obtains a word that is in content on the interface of the first application and that includes fewer characters than a preset quantity of characters, and uses the word as a title of the content.

The terminal may determine, based on a quantity of characters of a word on the interface of the first application, whether the word is the title. Usually, a quantity of characters of the title is comparatively small. Therefore, the terminal may pre-store the preset quantity of characters, and use, as the title, the word that is in the content on the interface of the first application and that includes fewer characters than the preset quantity of characters. The preset quantity of characters may be set based on experience, a size of the interface of the first application, a typesetting layout, or an experiment, or according to a requirement. For example, the preset quantity of characters may be 15 characters.

Implementation (3.3): The terminal obtains a word before a picture in content on the interface of the first application, and uses the word as a title of the content.

The terminal may determine whether content after a word is a picture, to determine whether the word is the title. Usually, there is a comparatively high probability that a picture follows the title. Therefore, the terminal may use, as the title, the word before the picture on the interface of the first application. For example, referring to FIG. 2A, content after words “XX iron-rich, fragrant oatmeal with red dates” is a picture. In this case, “XX iron-rich, fragrant oatmeal with red dates” is used as a title.

Implementation 4: If the object-of-attention includes a target word, the target word in the object-of-attention is extracted as the key information.

A style of the target word is different from that of another word other than the target word in a body text on the interface of the first application. The target word may be considered as a word in a special style on the interface of the first application. The style of a word may include a font size, a font, and a color of the word, whether the word is bold, and the like.

The implementation 4 includes but is not limited to at least one of the following implementations (4.1) to (4.3).

Implementation (4.1): The terminal extracts the target word from the object-of-attention based on a font size of a word in the object-of-attention, where a font size of the target word is greater than that of another word.

Specifically, the terminal may select, from the object-of-attention based on a font size of each word in the object-of-attention, a word whose font size is greater than that of another word, and use the word as the target word. For example, it is assumed that a paragraph includes 100 words, a font size of 95 words is 12 pt, and a font size of five words is 16 pt. In this case, the five words whose font size is 16 pt may be used as target words.

Implementation (4.2): The terminal obtains a target word in the object-of-attention based on a color of a word in the object-of-attention, where a color of the target word is a non-black-and-white color, or a color of the target word is different from that of another word.

Specifically, the terminal may select, from the object-of-attention based on a color of each word in the object-of-attention, a word whose color is a non-black-and-white color, and use the word as the target word. A non-black-and-white word whose color is not black, dark gray, or blue may be selected from the object-of-attention as the target word. In addition, the terminal may alternatively select, from the object-of-attention based on a color of each word in the object-of-attention, a word whose color is different from that of another word, and use the word as the target word.

Implementation (4.3): The terminal extracts a bold word from the object-of-attention as the target word.

Implementation 5: If the object-of-attention includes a preset symbol, a word in the preset symbol in the object-of-attention is extracted as the key information. The preset symbol may match a type of a resource. For example, the resource is a book, and the preset symbol may be double quotation marks. For example, referring to FIG. 4A, when the user sees a book “Children Who Grow up with Story Books” on the interface 401 of the first application, “Children Who Grow up with Story Books” in double quotation marks may be used as the key information.

Implementation 6: If the object-of-attention includes a preset keyword, a word adjacent to the preset keyword in the object-of-attention is extracted as the key information. The preset keyword may be used to identify a resource. For example, the preset keyword may be “name”. For example, the preset keyword may be “book”, “book name”, “film name”, or “movie”.

It should be noted that one of the foregoing implementations 1 to 6 may be performed, or the foregoing implementations 1 to 6 may be performed in combination. For example, the implementation 1 is combined with the implementation 6. The word adjacent to the preset keyword in the object-of-attention may be extracted, and a keyword in the word is extracted as the key information.

Step 1204: If an application switching instruction is received, the terminal triggers, on an interface of a second application, a target function of the second application based on the key information.

The application switching instruction is used to indicate to switch the second application to the foreground for running. A manner of receiving the application switching instruction includes but is not limited to at least one of the following implementations 1 and 2.

Implementation 1: The terminal receives, on a home screen, a display instruction for the second application. For example, as shown in FIG. 8B, a schematic diagram of the home screen 821 is presented. The terminal may display an icon of an e-commerce application A on the home screen 821, and the user may trigger an operation on the icon of the e-commerce application A. In this case, the terminal receives the display instruction for the second application.

Implementation 2: The terminal receives a display instruction for the second application by using a multi-application switching function. For example, referring to FIG. 9B, the terminal may display thumbnails of a plurality of background applications, and the user may perform an operation on a thumbnail of the second application in the thumbnails of the plurality of background applications. For example, the user clicks/taps a thumbnail of an e-commerce application A. In this case, the terminal receives the display instruction for the second application.

The target function is an information display function of the second application. The key information is displayed based on the target function, so that the key information can be combined with the function of the second application. For example, if the second application is an e-commerce application and the e-commerce application has a function of displaying commodity information in a form of a pop-up box, the target function may be a function of displaying a pop-up window. For another example, if the second application is a notepad application and the notepad application has a function of editing a text in an editable area, the target function may be a function of displaying the editable area.

In some possible embodiments, step 1204 includes, but is not limited to, one or a combination of the following implementations 1 to 12.

Implementation 1: The terminal displays the key information in an editable area on the interface of the second application.

The terminal may copy the key information to obtain a replica of the key information, and paste the replica of the key information to the editable area on the interface, to display the key information in the editable area. Specifically, the implementation 1 includes but is not limited to the following implementation (1.1).

Implementation (1.1): The key information is displayed in a search box on the interface of the second application.

The search box may trigger a resource search instruction. For example, referring to FIG. 2B, a search box 212 applied to an e-commerce application may be used to trigger a commodity search instruction. For example, referring to FIG. 3C, a search box 312 applied to a travel application may be used to trigger a scenic spot search instruction.

Specifically, if the terminal receives a confirmation instruction for the search box, the terminal may trigger a search function of the second application based on the key information. For example, the terminal may send the key information to the second application, and the second application may search for a resource based on the key information. For example, a name of a commodity or a picture of the commodity may be sent to an e-commerce application, and the e-commerce application may search for the commodity based on the name of the commodity or the picture of the commodity. For another example, a name of an e-book may be sent to a reading application, and the reading application may search for the e-book based on the name of the e-book. For another example, a name of a site may be sent to a navigation application, and the navigation application may search for the site based on the name of the site. For another example, a name of a site may be sent to a travel application, and the travel application may search for a travel plan for the site based on the name of the site. For another example, a name of music may be sent to an audio play application, and the audio play application may search for the music based on the name of the music. For another example, a name of a TV series may be sent to a video play application, and the video play application may search for the TV series based on the name of the TV series. For another example, a name of food may be sent to a take-out application, and the take-out application may search for the food based on the name of the food.

In the implementation (1.1), the terminal mines, by analyzing content on an interface of an application, key information used for searching for a resource, so that the terminal can directly search for the resource in a next application by using the mined key information. This avoids an operation of manually entering the key information on an interface of the next application by the user, and therefore can improve resource search efficiency and help quickly search for the resource. In addition, because a probability that a specific name of a resource appears on an interface of an application is comparatively low, in the prior art, a user needs to search for the resource in a next application by using some comparatively fuzzy keywords. In this case, because a keyword entered in the next application does not accurately represent the resource, many inaccurate results are found in the next application, resulting in low accuracy. However, in this embodiment, the terminal intelligently analyzes content on an interface of a previous application to find accurate key information, and the second application searches for a resource based on the accurate key information, so that search accuracy can be improved.

Optionally, in a scenario in which the second application is an information recording application, if a confirmation instruction for an editable area is received, the terminal may store the key information by using the second application. Specifically, the information recording application may be a memo application, a note application, a notepad application, an account book application, or the like. The editable area of the information recording application may be a text editing area. A storage option may be provided near the editable area of the information recording application. The storage option may be used to trigger an instruction for storing the key information. When the user triggers an operation on the storage option, the terminal may receive an instruction for storing the key information, the terminal may send the key information to the second application, and the second application may store the key information. In this scenario, the terminal mines, by analyzing content on an interface of an application, key information used for storing key information, and directly stores the mined key information in a next application. This avoids an operation of manually entering the key information on an interface of the next application by the user, and therefore can improve key information storage efficiency and help quickly store the key information.

Implementation 2: The terminal displays the key information in a form of a pop-up box on the interface of the second application.

The terminal may generate a pop-up box based on the key information, and display the pop-up box on the interface of the second application. The pop-up box includes the key information.

The pop-up box may be a picture box, a text box, or a picture and text box. The pop-up box may be but is not limited to a pop-up prompt. To be specific, the terminal may display the key information in a form of a pop-up prompt on the interface of the second application. The terminal may pre-store a preset position, and may display the key information in a form of a pop-up prompt at the preset position on the interface of the second application. For example, the key information may be displayed in a form of a pop-up prompt at the bottom of the interface of the second application. For another example, the key information may be displayed in a form of a pop-up prompt in a message notification area on the interface of the second application. Alternatively, the terminal may display the key information in a form of a pop-up prompt in an area adjacent to a control on the interface of the second application. For example, the key information may be displayed in a form of a pop-up prompt above a control on the interface of the second application. A position of the pop-up prompt is not limited in this embodiment. In addition, alternatively, the pop-up box may be but is not limited to a pop-up window. To be specific, the terminal may display the key information in a form of a pop-up window on the interface of the second application. The pop-up box may be a non-modal pop-up box, that is, the pop-up box can automatically disappear. For example, the terminal may perform timing when starting to display the pop-up box. When duration of timing exceeds preset duration, the pop-up box is no longer displayed, and the pop-up box automatically disappears. Alternatively, the pop-up box may be a modal pop-up box. If the terminal detects an operation triggered by the user on the pop-up box, the terminal no longer displays the pop-up box.

For example, the implementation 2 includes but is not limited to at least one of the following implementations (2.1) and (2.2).

Implementation (2.1): The terminal processes the key information based on a preset template to obtain text information, and the terminal displays the text information in a form of a pop-up box. The text information conforms to the preset template and includes the key information.

The implementation (2.1) includes but is not limited to at least one of the following implementations (2.1.1) to (2.1.3).

Implementation (2.1.1): The terminal may enter the key information into a preset position in the preset template, to obtain the text information.

Implementation (2.1.2): The terminal may first extract a keyword in the key information, and enter the keyword in the key information into a preset position in the preset template, to obtain the text information.

Implementation (2.1.3): The terminal may obtain a characteristic of a resource based on the key information, and obtain the text information based on the characteristic of the resource and the preset template.

For example, if the preset template is “Are you looking for YY?” and the key information is “XX iron-rich, fragrant oatmeal with red dates”, in the implementation (2.1.1), the preset position is a position of “YY” in “Are you looking for YY?”, and the terminal may obtain the text information according to the implementation (2.1.1) and based on the preset template, the preset position, and the key information, where the text information is “Are you looking for XX iron-rich, fragrant oatmeal with red dates?”; in the implementation (2.1.2), the terminal may extract a keyword “oatmeal” in the key information, and the terminal may obtain the text information according to the implementation (2.1.2) and based on the preset template and the key information, where the text information is “Are you looking for oatmeal?”; in the implementation (2.1.3), the terminal may extract a characteristic of a resource “oatmeal” as “nutritive and healthy”, and the terminal may obtain the text information according to the implementation (2.1.3) and based on the characteristic of the resource and the preset template, where the text information is “Are you looking for nutritive and healthy oatmeal?”.

Implementation (2.2): If the key information is a picture, the terminal displays the picture in a form of a pop-up box.

For example, referring to FIG. 6B, a pop-up box 612 includes a picture of “XX iron-rich, fragrant oatmeal with red dates”.

In another possible implementation, if the key information is identified from a picture on the interface of the first application, the terminal may display, in a form of a pop-up box, the picture from which the key information is identified. In another possible implementation, the terminal may search for a picture of a resource based on the key information, and display a found picture of the resource in a form of a pop-up box.

Implementation 3: The terminal stores the key information by using the second application.

Implementation 4: The terminal determines, based on the key information, a document corresponding to the key information, and displays the document.

In an example scenario, if the second application provides a reading function, the option in the pop-up box may be a reading option. After the user triggers an operation on the reading option, the terminal may trigger the reading function of the second application. For example, a name of an e-book or a picture of the e-book may be sent to the reading application, and the reading application may display content of the e-book based on the name of the e-book or the picture of the e-book, so that the user reads the e-book in the reading application. In this scenario, the terminal mines, by analyzing content on an interface of an application, key information used for displaying a resource, so that the terminal can directly display the resource in a next application by using the mined key information. This avoids an operation of manually entering the key information on an interface of the next application by the user, and therefore can improve resource display efficiency and help quickly display the resource.

Implementation 5: The terminal determines, based on the key information, a resource corresponding to the key information, and downloads the resource.

In an example scenario, if the second application provides a download function, the option in the pop-up box may be a download option. After the user triggers an operation on the download option, the terminal may trigger the download function of the second application. For example, a name of an application may be sent to a software download application, and the software download application may download the application based on the name of the application. For another example, a name of a thesis may be sent to a document sharing application, and the document sharing application may download the thesis based on the name of the paper. For another example, an identifier of code may be sent to a code hosting application, and the code hosting application may download the code based on the identifier of the code. For another example, an identifier of an image may be sent to a mirror site application, and the mirror site application may download the image based on the identifier of the image. In this scenario, the terminal mines, by analyzing content on an interface of an application, key information used for downloading a resource, so that the terminal can directly download the resource in a next application by using the mined key information. This avoids an operation of manually entering the key information on an interface of the next application by the user, and therefore can improve resource download efficiency and help quickly download the resource.

Implementation 6: The terminal determines, based on the key information, a resource corresponding to the key information, and adds the resource to favorites.

In an example scenario, the option in the pop-up box may be a favorites option.

After the user triggers an operation on the favorites option, the terminal may trigger a favorites function of the second application. For example, the terminal may send a name of a commodity to an e-commerce application, and the e-commerce application may add the commodity to a favorites folder of the user's account. In this scenario, the terminal mines, by analyzing content on an interface of an application, key information used for adding a resource to favorites, so that the terminal can directly add the resource to favorites in a next application by using the mined key information. This avoids an operation of manually entering the key information on an interface of the next application by the user, and therefore can improve efficiency for adding the resource to favorites and help quickly add the resource to favorites.

Implementation 7: The terminal determines, based on the key information, a resource corresponding to the key information, and purchases the resource.

In an example scenario, if the second application provides a purchase function, for example, the option in the pop-up box may be a purchase option, after the user triggers an operation on the purchase option, the terminal may trigger the purchase function of the second application. For example, the terminal may send a name of a commodity to an e-commerce application, and the e-commerce application may perform a transaction of the commodity based on the name of the commodity. In this scenario, the terminal mines, by analyzing content on an interface of an application, key information used for purchasing a resource, so that the terminal can directly purchase the resource in a next application by using the mined key information. This avoids an operation of manually entering the key information on an interface of the next application by the user, and therefore can improve resource purchase efficiency and help quickly purchase the resource.

Implementation 8: The terminal determines, based on the key information, an audio corresponding to the key information, and plays the audio.

In an example scenario, if the second application provides an audio play function, the option in the pop-up box may be a play option. After the user triggers an operation on the play option, the terminal may trigger the audio play function of the second application. For example, a name of a song may be sent to an audio play application, and the audio play application may play the song based on the name of the song. In this scenario, the terminal mines, by analyzing content on an interface of an application, key information used for playing a resource, so that the terminal can directly play the resource in a next application by using the mined key information. This avoids an operation of manually entering the key information on an interface of the next application by the user, and therefore can improve resource play efficiency and help quickly play the resource.

Implementation 9: The terminal determines, based on the key information, a video corresponding to the key information, and plays the video.

In an example scenario, if the second application provides a video play function, the option in the pop-up box may be a play option. After the user triggers an operation on the play option, the terminal may trigger the video play function of the second application. For example, a name of a video may be sent to a video play application, and the video play application may play the video based on the name of the video. In this scenario, the terminal mines, by analyzing content on an interface of an application, key information used for playing a video, so that the terminal can directly play the video in a next application by using the mined key information. This avoids an operation of manually entering the key information on an interface of the next application by the user, and therefore can improve video play efficiency and help quickly play the video.

Implementation 10: The terminal determines, based on the key information, a site corresponding to the key information, and plans a trip to reach the site.

In an example scenario, the option in the pop-up box may be a trip plan display option. After the user triggers an operation on the trip plan display option, the terminal may trigger a trip planning function of the second application. For example, a name of a scenic spot may be sent to a travel application, and the travel application may obtain, based on the name of the scenic spot, a plan for reaching the scenic spot, and display an interface. The interface includes a trip plan for reaching the scenic spot, so that the user browses the trip plan in the travel application.

Implementation 11: The terminal determines, based on the key information, a resource corresponding to the key information, and displays details about the resource.

In an example scenario, the option in the pop-up box may be a detail display option. After the user triggers an operation on the details display option, the terminal may trigger a detail interface display function of the second application. Specifically, the second application may display a detail interface, and the detail interface includes details about a resource. For example, the terminal may send a name of a commodity to an e-commerce application, and the e-commerce application may obtain a detail interface of the commodity based on the name of the commodity, and display the detail interface of the commodity.

Implementation 12: The terminal determines, based on the key information, a resource corresponding to the key information, and displays comment information about the resource.

In an example scenario, the option in the pop-up box may be a comment display option. After the user triggers an operation on the comment display option, the terminal may trigger a comment interface display function of the second application. Specifically, the second application may display a comment interface, and the comment interface may include a comment on a resource. For example, a name of a commodity may be sent to an e-commerce application, and the e-commerce application may obtain a comment interface of the commodity based on the name of the commodity, and display the comment interface of the commodity. The comment interface includes comments of a plurality of users on the commodity.

In some possible embodiments, if the terminal receives a confirmation instruction for the key information, any one or a combination of the foregoing implementations 1 to 12 may be triggered. Certainly, alternatively, after obtaining the key information, the terminal may directly perform any one or a combination of the implementations 1 to 12 without receiving a confirmation instruction. The confirmation instruction for the key information may be triggered based on a confirmation operation on the option in the pop-up box, or may be triggered based on an operation on a confirmation option near the search box. The terminal may send the key information to the second application, and the second application performs a corresponding function based on the key information. The following describes several example scenarios of triggering a function of the second application by using an example in which the confirmation instruction is triggered by an operation on the option in the pop-up box.

In some possible embodiments, a manner of displaying the key information may include: the terminal may generate two layers based on the key information and the second application, where the key information is an upper layer, and the interface of the second application is a lower layer, so that when the key information is displayed on the interface of the second application, an effect of displaying the key information in a hover box on the interface of the second application can be achieved; or the terminal may generate one layer based on the key information and the second application, where the layer includes the key information and the interface of the second application, to combine the key information and the interface of the second application into a whole interface, to achieve a display effect of embedding the key information into the interface of the second application.

It should be noted that step 1204 may be performed by the operating system of the terminal, or may be performed by the second application. This is not limited in this embodiment. Specifically, the operating system of the terminal may display the key information on the interface of the second application. In this process, the second application may be unaware of the key information. Alternatively, the operating system of the terminal may send the key information to the second application, and the second application may receive the key information, and display the key information on the interface based on the key information.

It should be noted that, when receiving the display instruction for the second application, the terminal may determine whether the key information matches the second application, and display the key information in the second application when the key information matches the second application. For example, the terminal may pre-store a correspondence between a semantic meaning of the key information and a type of the second application, and may obtain, based on the semantic meaning of the key information, a type of an application corresponding to the semantic meaning of the key information. When receiving the display instruction for the second application, the terminal may determine whether the type of the second application is the type of the application corresponding to the semantic meaning of the key information. When the type of the second application is the type of the application corresponding to the semantic meaning of the key information, the terminal displays the key information in the second application.

For example, when the key information is “Hengshan”, the terminal learns that the semantic meaning of the key information is a site. When switching to the second application, the terminal may determine whether the type of the second application is a travel application. When the type of the second application is a travel application, the terminal displays the key information in the travel application. For example, when the key information is “Children Who Grow up with Story Books”, the terminal learns that the semantic meaning of the key information is a book. When switching to the second application, the terminal may determine whether the type of the second application is a reading application. When the type of the second application is a reading application, the terminal displays the key information in the reading application.

According to the method provided in this embodiment, a function of automatically transferring key information on an interface of an application to an interface of a next application is implemented. The object-of-attention of the user is obtained from the interface of the first application based on the operation behavior of the user on the interface of the first application, the key information is extracted from the object-of-attention, and if the application switching instruction is received, the target function of the second application is triggered on the interface of the second application based on the key information. In this way, key information on an interface of an application may be automatically mined, and the key information on the interface of the application is automatically reused on an interface of a next application, thereby avoiding a complex operation of manually entering the key information on the interface of the next application by the user. This can improve efficiency for displaying the interface of the next application, thereby improving user experience.

This application further provides an interface display method. A difference from the interface display method in the embodiment of FIG. 12 lies in the following. In this method, a terminal may automatically learn of, through analysis, a to-be-switched-to next application, and give a corresponding prompt to a user, thereby avoiding a complex operation of manually finding the next application and starting the next application by the user. It should be noted that an embodiment of FIG. 14 focuses on a difference from the embodiment of FIG. 12. For steps similar to those in the embodiment of FIG. 12, refer to the embodiment of FIG. 12. Details are not described in the embodiment of FIG. 14.

FIG. 14 is a flowchart of an interface display method according to an embodiment of this application. As shown in FIG. 14, the method includes step 1401 to step 1405 that are performed by a terminal.

Step 1401: The terminal obtains key information from an interface of a first application based on an operation behavior of a user on the interface of the first application.

Step 1401 may include any one or a combination of the following implementations 1 and 2.

Implementation 1: An object-of-attention of the user is obtained from the interface of the first application based on the operation behavior of the user on the interface of the first application, and is used as the key information.

A difference of step 1401 from step 1202 and step 1203 lies in that the object-of-attention of the user may be directly used as the key information.

Implementation 2: An object-of-attention of the user is obtained from the interface of the first application based on the operation behavior of the user on the interface of the first application, and the key information is extracted from the object-of-attention.

Step 1402: The terminal performs semantic analysis on the key information to obtain a semantic meaning of the key information.

Step 1403: The terminal queries a correspondence between a semantic meaning and an application based on the semantic meaning of the key information, to obtain a second application corresponding to the semantic meaning of the key information.

The correspondence between a semantic meaning and an application may include at least one semantic meaning and an identifier of at least one application. For example, the correspondence between a semantic meaning and an application may be shown in Table 1. Each semantic meaning may correspond to an identifier of one or more applications. The correspondence between a semantic meaning and an application may be pre-stored on the terminal, or may be configured on the terminal according to a requirement.

TABLE 1

| Semantic | |
|---|---|
| meaning | Application identifier |
| Commodity | E-commerce application A |
| Site | Travel application B and navigation application C |
| Game item | Game application D |
| Book | Reading application E |
| Application | Software download application F |
| Movie | Ticket booking application G and video play |
| | application H |
| TV series | Video play application H |
| Music | Audio play application I |
| Food | Take-out application K and recipe application L |
| Name | Social application M |

In an example scenario, if the key information on the interface of the first application is “XX iron-rich, fragrant oatmeal with red dates” and the terminal learns that a semantic meaning of the key information is a commodity, the terminal may learn, based on the correspondence shown in Table 1, that an identifier of the second application is the e-commerce application A, and then generate prompt information “Go to an e-commerce application A to view a comment?”; or if the key information on the interface of the first application is “Hengshan” and the terminal learns that a semantic meaning of the key information is a site, the terminal may learn, based on the correspondence shown in Table 1, that an identifier of the second application is the travel application B, and then generate prompt information “Go to a travel application B to view a travel guide?”.

Step 1404: The terminal displays prompt information on the interface of the first application.

The prompt information is used to prompt the user whether to jump to the second application. For example, the prompt information may include a name of the second application, an icon of the second application, or a thumbnail of the second application. The prompt information may be displayed in a preset area on the interface of the first application. The preset area may be bottom of the interface of the first application, a corner of the interface of the first application, or the like.

In an example scenario, referring to FIG. 5A, the user sees a recommendation article for “XX iron-rich, fragrant oatmeal with red dates” on an interface 501 of a community application, and carefully reads the recommendation article. The terminal determines, based on a browsing speed of the user for the interface 501 of the community application, that the recommendation article is an object-of-attention of the user, analyzes the recommendation article, and learns that key information is “XX iron-rich, fragrant oatmeal with red dates”. In this case, prompt information “Go to an e-commerce application A to view a comment?” is displayed at the bottom of the interface 501 of the community application. When the user clicks/taps the prompt information “Go to an e-commerce application A to view a comment?”, the terminal displays a detail interface of “XX iron-rich, fragrant oatmeal with red dates” in the e-commerce application.

The prompt information may be considered as a jump channel between the first application and the second application. The terminal may directly switch from the interface of the first application to an interface of the second application according to an instruction received on the prompt information. In this way, when browsing the interface of the first application, the user may directly enter the interface of the second application by triggering an operation on the prompt information on the interface of the first application, thereby avoiding a complex operation of manually selecting, by the user, the second application from a large quantity of applications installed on the terminal, and also avoiding an operation of manually starting the second application by the user. This can improve efficiency for providing a function of the second application, and can quickly provide the function of the second application, thereby improving user experience.

With respect to a manner of generating the prompt information, in a possible implementation, the terminal may generate the prompt information based on the identifier of the second application, the key information, and a preset template. The prompt information includes the identifier of the second application and an identifier of a resource, and the prompt information conforms to the preset template. For example, the preset template may be “Go to an application XX to look at a resource YY?”. Assuming that the identifier of the second application is the “reading application E” and the identifier of the resource is “Children Who Grow up with Story Books”, the prompt information may be “Go to a reading application E to look at Children Who Grow up with Story Books?”.

Step 1405: The terminal displays the interface of the second application if a confirmation instruction for the prompt information is received.

In some possible embodiments, the terminal may trigger a target function of the second application on the interface of the second application based on the key information. For a specific process, refer to step 1204 in the embodiment of FIG. 12. For example, one or a combination of the implementations 1 to 12 in step 1204 may be performed. Details are not described herein again.

According to the method provided in this embodiment, a function of automatically indicating a to-be-switched-to application on an interface of a previous application is implemented. The terminal queries the correspondence between a semantic meaning and an application based on the semantic meaning of the key information, to obtain the second application corresponding to the semantic meaning of the key information; displays the prompt information on the interface of the first application; and displays the interface of the second application if the confirmation instruction for the prompt information is received. In this way, by mining information on an interface of an application, a next application that needs to be used by the user is learned of through intelligent analysis, thereby avoiding a complex operation of manually searching for the next application and starting the next application by the user. This can improve efficiency for displaying the interface of the next application, thereby improving user experience.

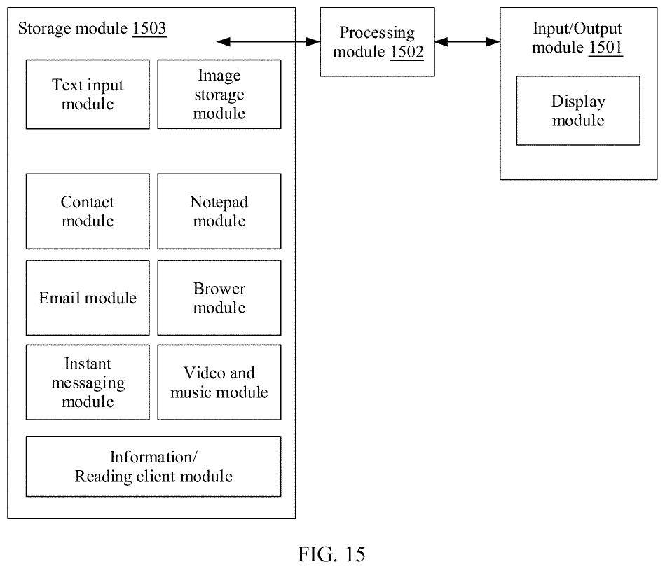

In some possible embodiments, FIG. 15 shows a diagram of a logical architecture of the interface display method in the embodiment of FIG. 12 and the embodiment of FIG. 14. The logical architecture includes the following functional modules.

An input/output module 1501 is configured to: enable, by using a sensor such as a touch sensor or a microphone, a user to enter related data by using the input/output module; and output a feedback to the user by using a screen, a speaker, or the like. For example, the input/output module 1501 may include a display module, and the display module is configured to display information exchanged with the user. On a physical entity, the display module and the input/output module 1501 may be a touchscreen.

A processing module 1502 is configured to perform actions such as determining, analyzing, and calculating under a specific condition, and send an instruction to another module. In the embodiment of FIG. 12 and the embodiment of FIG. 14, the processing module 1502 may be configured to detect a browsing speed of a user.

A storage module 1503 is configured to store data. The storage module 1503 may include a text input module, an image storage module, a fingerprint module, a notepad module, an email module, a video and music module, a browser module, an instant messaging module, and an information/reading client module. The text input module is configured to store a text. The image storage module is configured to store an image. The fingerprint module is configured to record fingerprint information entered by a user. A contact module is configured to store and manage contact information (an address book or a contact list) of a user, including adding one or more names to the contact list. The notepad module is configured to store memo information of a user that is in a text format or an image format. The email module is configured to store an email of a user. The video and music module includes a video player and a music player. The browser module includes an executable instruction for accessing the Internet according to a user instruction. The instant messaging module includes executable instructions for transmitting and viewing an instant message. The information/reading client module includes an executable instruction for browsing information. The storage module 1503 is further configured to store an average browsing speed of a user and other temporary data.

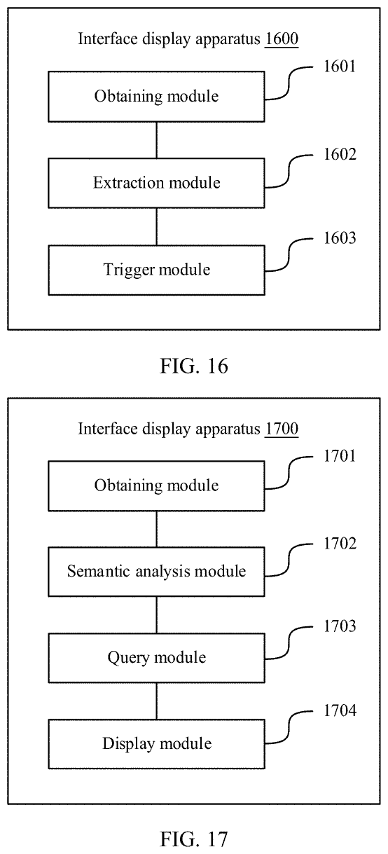

FIG. 16 is a schematic structural diagram of an interface display apparatus 1600 according to an embodiment of this application. As shown in FIG. 16, the apparatus 1600 includes an obtaining module 1601, configured to perform step 1202; an extraction module 1602, configured to perform step 1203; and a trigger module 1603, configured to perform step 1204.

Optionally, the trigger module 1603 is configured to perform one implementation or a combination of a plurality of implementations of implementation 1 to implementation 12 in step 1204.

Optionally, the trigger module 1603 is configured to display the key information in a form of a pop-up prompt or in a form of a pop-up window.

Optionally, the trigger module 1603 is configured to perform any one of the following:

processing the key information based on a preset template to obtain text information, and displaying the text information in a form of a pop-up box, where the text information conforms to the preset template and includes the key information; and

if the key information is a picture, displaying the picture in a form of a pop-up box.

Optionally, the obtaining module 1601 is configured to perform step 1 and step 2 in step 1202.

Optionally, the extraction module 1602 is configured to perform one implementation or a combination of a plurality of implementations of implementation 1 to implementation 6 in step 1203.

It should be noted that, when the interface display apparatus 1600 provided in the embodiment in FIG. 16 displays an interface, division of the foregoing functional modules is merely used as an example for description. In actual application, the foregoing functions may be allocated and completed by different functional modules according to a requirement; that is, an internal structure of a terminal is divided into different functional modules, to implement all or some of the functions described above. In addition, the interface display apparatus 1600 provided in this embodiment and the interface display method embodiment belong to a same concept. For a specific implementation process of the interface display apparatus 1600, refer to the method embodiment. Details are not described herein again.

FIG. 17 is a schematic structural diagram of an interface display apparatus 1700 according to an embodiment of this application. As shown in FIG. 17, the apparatus 1700 includes an obtaining module 1701, configured to perform step 1401; a semantic analysis module 1702, configured to perform step 1402; a query module 1703, configured to perform step 1403; and a display module 1704, configured to perform step 1404. The display module 1704 is further configured to perform step 1405.

Optionally, the obtaining module 1701 is configured to perform either of implementation 1 and implementation 2 or a combination of implementation 1 and implementation 2 in step 1401.

Optionally, the display module 1704 is configured to perform a step similar to step 1204.

It should be noted that, when the interface display apparatus 1700 provided in the embodiment in FIG. 17 displays an interface, division of the foregoing functional modules is merely used as an example for description. In actual application, the foregoing functions may be allocated and completed by different functional modules according to a requirement, that is, an internal structure of a terminal is divided into different functional modules, to implement all or some of the functions described above. In addition, the interface display apparatus 1700 provided in this embodiment and the interface display method embodiment belong to a same concept. For a specific implementation process of the interface display apparatus 1700, refer to the method embodiment. Details are not described herein again.

In an example embodiment, a computer-readable storage medium is further provided, for example, a memory including an instruction. The instruction may be executed by a processor to complete the interface display method in the foregoing embodiment. For example, the computer-readable storage medium may be a read-only memory (ROM), a random access memory (RAM), a compact disc read-only memory (CD-ROM), a magnetic tape, a floppy disk, an optical data storage device, and the like.

In an example embodiment, a computer program product is also provided. The computer program product includes computer program code, and when the computer program code is run by a terminal, the terminal is enabled to perform the foregoing interface display method.

In an example embodiment, a chip is also provided. The chip includes a processor. The processor is configured to invoke, from a memory, an instruction stored in the memory and run the instruction, so that a terminal on which the chip is installed performs the foregoing interface display method.

In an example embodiment, another chip is provided. The another chip includes an input interface, an output interface, a processor, and a memory. The input interface, the output interface, the processor, and the memory are connected to each other through an internal connection path. The processor is configured to execute code in the memory, and when the code is executed, the processor is configured to perform the foregoing interface display method.

All or some of the foregoing embodiments may be implemented by using software, hardware, firmware, or any combination thereof. When software is used to implement the embodiments, the embodiments may be implemented completely or partially in a form of a computer program product. The computer program product includes one or more computer program instructions. When the computer program instructions are loaded and executed on the computer, the procedure or functions according to the embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, a computer, a server, or a data center to another website, computer, server, or data center in a wired or wireless manner. The computer-readable storage medium may be any usable medium accessible by a computer, or a data storage device, such as a server or a data center, integrating one or more usable media. The usable medium may be a magnetic medium (e.g., a floppy disk, a hard disk, or a magnetic tape), an optical medium (e.g., a digital video disc (DVD)), a semiconductor medium (e.g., a solid-state drive), or the like.

The term “and/or” in this application describes only an association relationship for describing associated objects and represents that three relationships may exist. For example, A and/or B may represent the following three cases: Only A exists, both A and B exist, and only B exists. In addition, the character “I” in this application generally indicates an “or” relationship between the associated objects.

In this application, the term “a plurality of” means two or more. For example, a plurality of data packets are two or more data packets.

In this application, terms such as “first” and “second” are used to distinguish between same items or similar items that have basically same functions. A person skilled in the art may understand that the terms such as “first” and “second” do not limit a quantity and an execution sequence.

A person of ordinary skill in the art may understand that all or some of the steps of the embodiments may be implemented by hardware or a program instructing related hardware. The program may be stored in a computer-readable storage medium. The storage medium may include: a read-only memory, a magnetic disk, or an optical disc.

The foregoing descriptions are merely optional embodiments of this application, but are not intended to limit this application. Any modification, equivalent replacement, or improvement made without departing from the spirit and principle of this application should fall within the protection scope of this application.

1. An interface display method, wherein the method comprises:
obtaining an object-of-attention of a user from an interface of a first application based on an operation behavior of the user on the interface of the first application;
extracting key information from the object-of-attention; and
responsive to receiving an application switching instruction, triggering, on an interface of a second application, a target function of the second application based on the key information, wherein the application switching instruction is used to indicate to switch the second application to the foreground for running.

2. The method according to claim 1, wherein the obtaining the object-of-attention of the user from the interface of the first application based on the operation behavior of the user on the interface of the first application comprises at least one of the following:
identifying, based on the operation behavior of the user on the interface of the first application, an attention degree of at least one piece of content on the interface of the first application; and
selecting, from the at least one piece of content, content whose attention degree meets a preset condition as selected content, and using the selected content as the object-of-attention.

3. The method according to claim 2, wherein the identifying the attention degree of the at least one piece of content on the interface of the first application based on the operation behavior of the user on the interface of the first application comprises at least one of the following:
identifying a first attention degree of the at least one piece of content based on a selection operation of the user on the interface of the first application, wherein the first attention degree of each piece of content is used to indicate whether the user triggers the selection operation on the piece of content;
identifying a second attention degree of the at least one piece of content based on a saving operation of the user on the interface of the first application, wherein the second attention degree of each piece of content is used to indicate whether the user triggers the saving operation on the piece of content;
identifying a third attention degree of the at least one piece of content based on a screenshot operation of the user on the interface of the first application, wherein the third attention degree of each piece of content is used to indicate whether the piece of content is in a screenshot;
identifying a fourth attention degree of the at least one piece of content based on a publishing operation of the user on the interface of the first application, wherein the fourth attention degree of each piece of content is used to indicate whether the user publishes the piece of content;
detecting, by using a camera, a duration in which sight of the user stays on each piece of content on the interface of the first application, and using the duration as a fifth attention degree of the at least one piece of content;
detecting a sliding speed of the user for each piece of content on the interface of the first application, and using the sliding speed as a sixth attention degree of the at least one piece of content;
obtaining a browsing speed for the at least one piece of content based on a browsing behavior of the user on the interface of the first application, and using the browsing speed as a seventh attention degree of the at least one piece of content; and
identifying an eighth attention degree of the at least one piece of content based on an interaction behavior of the user on the interface of the first application, wherein the eighth attention degree of each piece of content is used to indicate whether the user triggers an interaction behavior on the piece of content.

4. The method according to claim 1, wherein the triggering, on the interface of the second application, the target function of the second application based on the key information comprises at least one of the following:
displaying the key information in an editable area on the interface of the second application;
displaying the key information in a pop-up box on the interface of the second application;
storing the key information by using the second application;
determining, based on the key information, a document corresponding to the key information, and displaying the document;
determining, based on the key information, a resource corresponding to the key information, and downloading the resource;
determining, based on the key information, a resource corresponding to the key information, and adding the resource to favorites;
determining, based on the key information, a resource corresponding to the key information, and purchasing the resource;
determining, based on the key information, an audio corresponding to the key information, and playing the audio;
determining, based on the key information, a video corresponding to the key information, and playing the video;
determining, based on the key information, a site corresponding to the key information, and planning a trip to reach the site;
determining, based on the key information, a resource corresponding to the key information, and displaying details about the resource; and
determining, based on the key information, a resource corresponding to the key information, and displaying comment information about the resource.

5. The method according to claim 4, wherein the displaying the key information in the editable area on the interface of the second application comprises:
displaying the key information in a search box on the interface of the second application.

6. The method according to claim 4, wherein the displaying the key information in the pop-up box on the interface of the second application comprises at least one of the following:
displaying the key information in a pop-up prompt on the interface of the second application; and
displaying the key information in a pop-up window on the interface of the second application.

7. The method according to claim 4, wherein the displaying the key information in the pop-up box on the interface of the second application comprises at least one of the following:
processing the key information based on a preset template to obtain text information, and displaying the text information in the pop-up box, wherein the text information conforms to the preset template and comprises the key information; and
responsive to determining that the key information comprises a picture, displaying the picture in the pop-up box.

8. The method according to claim 1, wherein the extracting key information from the object-of-attention comprises at least one of the following:
responsive to determining that the object-of-attention comprises a text, extracting a keyword in the text, and using the keyword as the key information;
responsive to determining that the object-of-attention comprises a picture, analyzing the picture to obtain the key information;
responsive to determining that the object-of-attention comprises a title, extracting the title from the object-of-attention, and using the title as the key information;
responsive to determining that the object-of-attention comprises a target word, extracting the target word from the object-of-attention, and using the target word as the key information, wherein a style of the target word is different from that of another word other than the target word in a body text on the interface of the first application;
responsive to determining that the object-of-attention comprises a preset symbol, extracting a word in the preset symbol from the object-of-attention, and using the word as the key information; and
responsive to determining that the object-of-attention comprises a preset keyword, extracting a word adjacent to the preset keyword from the object-of-attention, and using the word as the key information.

9. An interface display method, wherein the method comprises:
obtaining key information from an interface of a first application based on an operation behavior of a user on the interface of the first application;
performing semantic analysis on the key information to obtain a semantic meaning of the key information;
querying a correspondence between a-semantic meanings and applications based on the semantic meaning of the key information, to obtain a second application corresponding to the semantic meaning of the key information;
displaying prompt information on the interface of the first application, wherein the prompt information is used to prompt the user whether to jump to the second application; and
displaying an interface of the second application responsive to receiving a confirmation instruction for the prompt information.

10. The method according to claim 9, wherein the obtaining key information from the interface of the first application based on the operation behavior of the user on the interface of the first application comprises at least one of the following:
obtaining an object-of-attention of the user from the interface of the first application based on the operation behavior of the user on the interface of the first application, and using the object-of-attention as the key information; and
obtaining an object-of-attention of the user from the interface of the first application based on the operation behavior of the user on the interface of the first application, and extracting the key information from the object-of-attention.

11. The method according to claim 9, wherein the displaying the interface of the second application comprises:
displaying the key information on the interface of the second application based on a target function of the second application.

12. A terminal, comprising at least one processor and a memory storing at least one instruction, which when loaded and executed by the processor, causes the processor to perform operations comprising:
obtaining an object-of-attention of a user from an interface of a first application based on an operation behavior of the user on the interface of the first application;
extracting key information from the object-of-attention; and
responsive to receiving an application switching instruction, triggering, on an interface of a second application, a target function of the second application based on the key information, wherein the application switching instruction is used to indicate to switch the second application to the foreground for running.

13. The terminal according to claim 12, wherein the obtaining the object-of-attention of the user from the interface of the first application based on the operation behavior of the user on the interface of the first application comprises at least one of the following:
identifying, based on the operation behavior of the user on the interface of the first application, an attention degree of at least one piece of content on the interface of the first application; and
selecting, from the at least one piece of content, content whose attention degree meets a preset condition as selected content, and using the selected content as the object-of-attention.

14. The terminal according to claim 13, wherein the identifying the attention degree of the at least one piece of content on the interface of the first application based on the operation behavior of the user on the interface of the first application comprises at least one of the following:
identifying a first attention degree of the at least one piece of content based on a selection operation of the user on the interface of the first application, wherein the first attention degree of each piece of content is used to indicate whether the user triggers a selection operation on the piece of content;
identifying a second attention degree of the at least one piece of content based on a saving operation of the user on the interface of the first application, wherein the second attention degree of each piece of content is used to indicate whether the user triggers a saving operation on the piece of content;
identifying a third attention degree of the at least one piece of content based on a screenshot operation of the user on the interface of the first application, wherein the third attention degree of each piece of content is used to indicate whether the content is in a screenshot;
identifying a fourth attention degree of the at least one piece of content based on a publishing operation of the user on the interface of the first application, wherein the fourth attention degree of each piece of content is used to indicate whether the user publishes the piece of content;
detecting, by using a camera, a duration in which sight of the user stays on each piece of content on the interface of the first application, and using the duration as a fifth attention degree of the at least one piece of content;
detecting a sliding speed of the user for each piece of content on the interface of the first application, and using the sliding speed as a sixth attention degree of the at least one piece of content;
obtaining a browsing speed for the at least one piece of content based on a browsing behavior of the user on the interface of the first application, and using the browsing speed as a seventh attention degree of the at least one piece of content; and
identifying an eighth attention degree of the at least one piece of content based on an interaction behavior of the user on the interface of the first application, wherein the eighth attention degree of each piece of content is used to indicate whether the user triggers an interaction behavior on the piece of content.

15. The terminal according to claim 12, wherein the triggering, on the interface of the second application, the target function of the second application based on the key information comprises any at least one of the following:
displaying the key information in an editable area on the interface of the second application;
displaying the key information in a pop-up box on the interface of the second application;
storing the key information by using the second application;
determining, based on the key information, a document corresponding to the key information, and displaying the document;
determining, based on the key information, a resource corresponding to the key information, and downloading the resource;
determining, based on the key information, a resource corresponding to the key information, and adding the resource to favorites;
determining, based on the key information, a resource corresponding to the key information, and purchasing the resource;
determining, based on the key information, an audio corresponding to the key information, and playing the audio;
determining, based on the key information, a video corresponding to the key information, and playing the video;
determining, based on the key information, a site corresponding to the key information, and planning a trip to reach the site;
determining, based on the key information, a resource corresponding to the key information, and displaying details about the resource; and
determining, based on the key information, a resource corresponding to the key information, and displaying comment information about the resource.

16. The terminal according to claim 15, wherein the displaying the key information in the editable area on the interface of the second application comprises:
displaying the key information in a search box on the interface of the second application.

17. The terminal according to claim 15, wherein the displaying the key information the pop-up box on the interface of the second application comprises any at least one of the following:
displaying the key information in a pop-up prompt on the interface of the second application; and
displaying the key information in a pop-up window on the interface of the second application.

18. The terminal according to claim 15, wherein the displaying the key information the pop-up box on the interface of the second application comprises at least one of the following:
processing the key information based on a preset template to obtain text information, and displaying the text information the pop-up box, wherein the text information conforms to the preset template and comprises the key information; and
responsive to determining that the key information comprises a picture, displaying the picture the pop-up box.

19. The terminal according to claim 12, wherein the extracting key information from the object-of-attention comprises at least one of the following:
responsive to determining that the object-of-attention comprises a text, extracting a keyword in the text, and using the keyword as the key information;
responsive to determining that the object-of-attention comprises a picture, analyzing the picture to obtain the key information;
responsive to determining that the object-of-attention comprises a title, extracting the title from the object-of-attention, and using the title as the key information;
responsive to determining that the object-of-attention comprises a target word, extracting the target word from the object-of-attention, and using the target word as the key information, wherein a style of the target word is different from that of another word other than the target word in a body text on the interface of the first application;
responsive to determining that the object-of-attention comprises a preset symbol, extracting a word in the preset symbol from the object-of-attention, and using the word as the key information; and
responsive to determining that the object-of-attention comprises a preset keyword, extracting a word adjacent to the preset keyword from the object-of-attention, and using the word as the key information.
